(19) United States
(12) Patent Application Publication
(10) Pub. No.: US 2025/0220722 A1
(43) Pub. Date: Jul. 3, 2025

(54) METHOD AND APPARATUS FOR HANDLING CONFIGURATION FOR AMBIENT IOT DEVICE IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW); Yu-Hsuan Guo, Taipei City (TW); Ming-Che Li, Taipei City (TW)

(21) Appl. No.: 18/986,003

(22) Filed: Dec. 18, 2024

Related U.S. Application Data
(60) Provisional application No. 63/616,401, filed on Dec. 29, 2023.
(60) Provisional application No. 63/616,424, filed on Dec. 29, 2023.

(51) Int. Cl. H04W 74/0833; H04W 68/02; H04W 74/08

(52) U.S. Cl. CPC H04W 74/0833; H04W 68/02; H04W 74/0866

(57) ABSTRACT

Methods, systems, and apparatuses are provided for handling configurations for ambient Internet of Things (IoT) in a wireless communication system, wherein a method of a User Equipment (UE)/device comprises receiving a first signaling of triggering a random access procedure, wherein the first signaling is for more than one UE/device, and triggering, in response to receiving the first signaling, the random access procedure and performing a first transmission of the random access procedure based on a first resource or a first configuration provided in the first signaling.

### CROSS-REFERENCE TO RELATED APPLICATIONS

The present Application claims priority to and the benefit of U.S. Provisional Patent Application Ser. No. 63/616,401, filed Dec. 29, 2023, and U.S. Provisional Patent Application Ser. No. 63/616,424, filed Dec. 29, 2023; with each of the referenced applications and disclosures fully incorporated herein by reference.

### FIELD

This disclosure generally relates to wireless communication networks and, more particularly, to a method and apparatus for handling configurations for ambient Internet of Things (IoT) devices in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling configurations for ambient Internet of Things (IoT) in a wireless communication system. As such, a lightweight signaling procedure can be achieved for an ambient IoT User Equipment (UE)/device, e.g., signaling overhead could be reduced for data/signaling transmission. The ambient IoT UE/device can perform an (random) access procedure triggered by the network and efficiently acquire resources to perform transmission in the (random) access procedure.

In various embodiments, a method of a UE/device comprises receiving a first signaling of triggering a random access procedure, wherein the first signaling is for more than one UE/device, and triggering, in response to receiving the first signaling, the random access procedure and performing a first transmission of the random access procedure based on a first resource or a first configuration provided in the first signaling.

In various embodiments, a method of a reader comprises transmitting a first signaling of triggering a random access procedure, wherein the first signaling is for more than one UE/device, and receiving a first transmission of the random access procedure from a UE/device, wherein the first transmission is triggered in response to the first signaling, and wherein the first transmission is performed or received based on a first resource or a first configuration provided in the first signaling.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure 4.2.1.1-1: Topology 1, from 3GPP TR 38.848 V18.0.0.

FIG. 6 is a reproduction of Figure 4.2.1.2-1: Topology 2, from 3GPP TR 38.848 V18.0.0.

FIG. 7A is a reproduction of Figure 9.2.6-1(a): Random Access Procedures, CBRA with 4-step RA type, from 3GPP TS 38.300 V17.6.0.

FIG. 7B is a reproduction of Figure 9.2.6-1(b): Random Access Procedures, CBRA with 2-step RA type, from 3GPP TS 38.300 V17.6.0.

FIG. 7C is a reproduction of Figure 9.2.6-1(c): Random Access Procedures, CFRA with 4-step RA type, from 3GPP TS 38.300 V17.6.0.

FIG. 7D is a reproduction of Figure 9.2.6-1(d): Random Access Procedures, CFRA with 2-step RA type, from 3GPP TS 38.300 V17.6.0.

FIG. 8 is a reproduction of Figure 9.2.6-2: Fallback for CBRA with 2-step RA type, from 3GPP TS 38.300 V17.6.0.

FIG. 9 is a flow diagram of a method of a first UE in a wireless communication system comprises determining or deriving (at least) a first configuration by a first method, wherein the first configuration is determined or derived by a second UE by a second method, in accordance with embodiments of the present invention.

FIG. 10 is a flow diagram of a method of a network node in a wireless communication system comprises configuring a first UE with (at least) a first configuration by a first method, and configuring a second UE with (at least) the first configuration by a second method, in accordance with embodiments of the present invention.

FIG. 11 is a flow diagram of a method of a first UE in a wireless communication system comprises performing a transmission or reception without at least a first configuration, wherein the first configuration is required by a second UE to perform the transmission or reception, in accordance with embodiments of the present invention.

FIG. 12 is a flow diagram of a method of a network node in a wireless communication system comprises configuring a second UE with (at least) a first configuration for the second UE to perform a transmission or reception, and not configuring a first UE with (at least) the first configuration for the first UE to perform the transmission or reception, in accordance with embodiments of the present invention.

FIG. 13 is a flow diagram of a method of a UE in a wireless communication system comprises receiving a signaling from network, and in response to receiving the signaling, determining whether a first condition is fulfilled or not, in accordance with embodiments of the present invention.

FIG. 14 is a flow diagram of a method of a UE in a wireless communication system comprises receiving a first signaling of triggering a random access procedure, and triggering, in response to receiving the first signaling, the random access procedure and performing a first transmission of the random access procedure based on a first resource or a first configuration provided in the first signaling, in accordance with embodiments of the present invention.

FIG. 15 is a flow diagram of a method of a reader in a wireless communication system comprises transmitting a first signaling of triggering a random access procedure, and receiving a first transmission of the random access procedure from a UE, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234058, “Study on solutions for Ambient IoT (Internet of Things) in NR”; [2] 3GPP TR 38.848 V18.0.0 (2023-09) 3GPP; TSG RAN; Study on Ambient IoT (Internet of Things) in RAN (Release 18); [3] 3GPP TS 38.321 V17.6.0 (2023-09) 3GPP; TSG RAN; NR; MAC protocol specification (Release 17); [4] 3GPP TS 38.300 V17.6.0 (2023-09) 3GPP; TSG RAN; NR; NR and NG-RAN Overall Description (Release 17); [5] 3GPP TS 38.331 V17.6.0 (2023-09) 3GPP; TSG RAN; NR; RRC protocol specification (Release 17); and [6] 3GPP TS 38.213 V17.7.0 (2023-09) 3GPP; TSG RAN; NR; Physical layer procedures for control (Release 17). The standards and documents listed above are hereby expressly and fully incorporated herein by reference in their entirety.

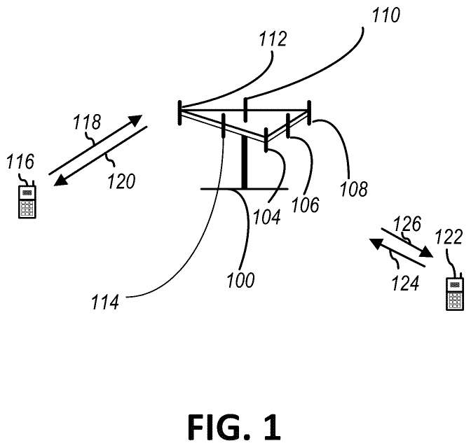

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

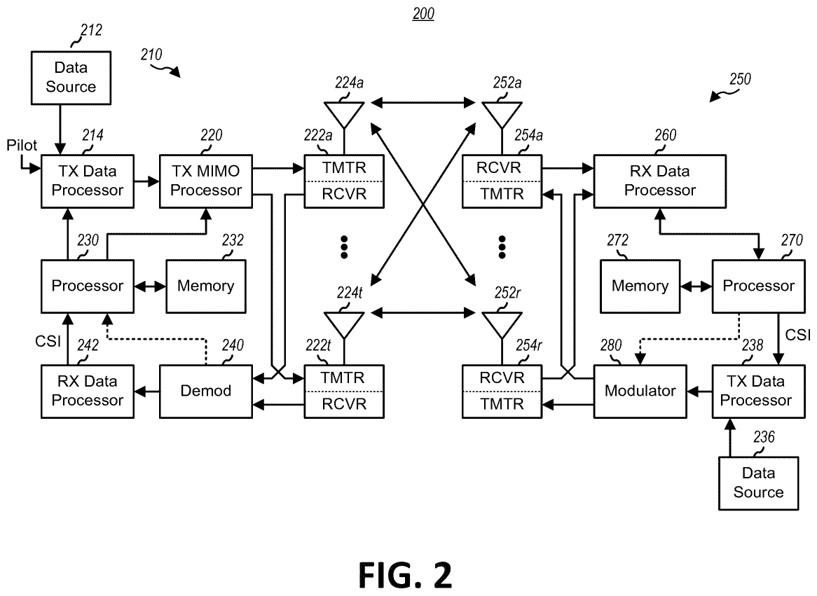

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

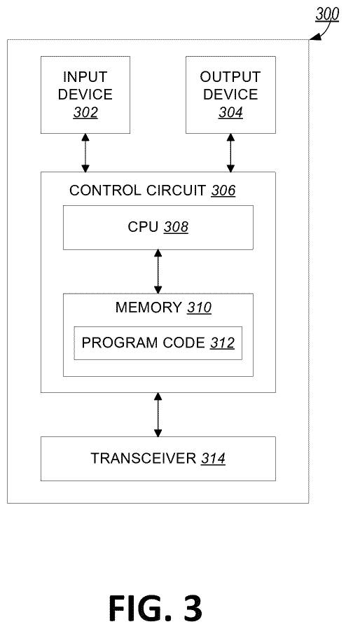

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

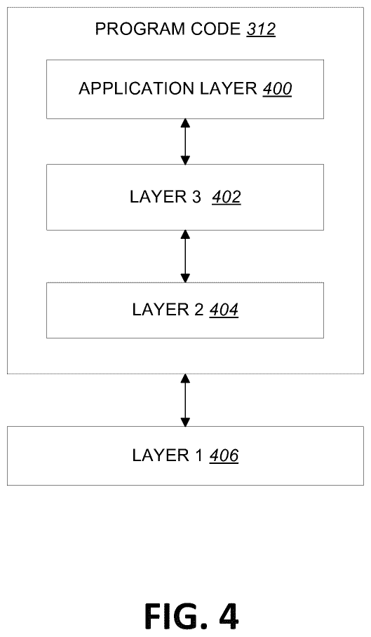

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The description of the study item of ambient Internet of Things (IoT) is specified in [1] RP-234058 as below:

### **************************************Quotation Start [1]**************************************

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

TR 22.840 is being developed by SA1 to capture use cases, traffic scenarios, device constraints of ambient power-enabled Internet of Things and identify new potential service requirements as well as new KPIs. SA1 are considering devices being either battery-less or with limited energy storage capability (i.e., using a capacitor) and the energy is provided through the harvesting of radio waves, light, motion, heat, or any other power source that could be seen suitable.

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application in TR 22.840 is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

TSG RAN has completed a Rel-18 RAN-level SI on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and eMTC), and shall address use cases and scenarios that cannot otherwise be fulfilled based on existing 3GPP LPWA IoT technologies.

### 4 Objective

### 4.1 Objective of SI or Core Part WI or Testing Part WI

This study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power.

### General Scope

The definitions provided in TR 38.848 are taken into this SI, and the following are the exclusive general scope:
A. The overall objective shall be to study a harmonized air interface design with minimized differences (where necessary) for Ambient IoT to enable the following devices:
   i. ˜1 μW peak power consumption, has energy storage, initial sampling frequency offset (SFO) up to 104 ppm, neither DL nor UL amplification in the device. The device's UL transmission is backscattered on a carrier wave provided externally.
   ii. ≤ a few hundred μW peak power consumption¹, has energy storage, initial sampling frequency offset (SFO) up to 104 ppm, both DL and/or UL amplification in the device. The device's UL transmission may be generated internally by the device, or be backscattered on a carrier wave provided externally.
      X is to be decided in WGs.
      Coverage design target: Maximum distance of 10-50 m with device indoors as per TR 38.848: “ . . . a range that WGs can sub-select within”.
      For Topologies 1 & 2 (UE as intermediate node under NW control) per TR 38.848, with no RRC states, no mobility (i.e. at least no cell selection/re-selection-like function), no HARQ, no ARQ.
   NOTE 1: It is to be understood that “≤ a few hundred μW” means WGs are not tasked with setting a particular value, and that it will be for WG discussions to determine if a presented design with corresponding power consumption satisfies the “≤ a few hundred μW” requirement.
B. Deployment Scenarios with the following characteristics, referenced to the tables in Clause 4.2.2 of TR 38.848:
   Deployment scenario 1 with Topology 1
      Basestation and coexistence characteristics: Micro-cell, co-site.
   Deployment scenario 2 with Topology 2 and UE as intermediate node, under network control
      Basestation and coexistence characteristics: Macro-cell, co-site
      The location of intermediate node is indoor
C. FR1 licensed spectrum in FDD.
D. Spectrum deployment in-band to NR, in guard-band to LTE/NR, in standalone band(s).
E. Traffic types DO-DTT, DT, with focus on rUCI (indoor inventory) and rUC4 (indoor command).
   From RAN #104, the study will assess whether the harmonized air interface design (per bullet ‘A’ above) can address the DO-A (Device-originated autonomous) use case, only to identify which part(s) of the harmonized air interface design (per bullet ‘A’ above) is/are not sufficient for the DO-A use case.

Transmission from Ambient IoT device (including backscattering when used) can occur at least in UL spectrum.

The following objectives are set, within the General Scope:
. . .
2. Study necessary and feasible solutions for Ambient IoT as prescribed in the General Scope, including decisions on which functions, procedures, etc. are needed and not needed, and ensuring at least the required functionalities in Section 6.2 of TR 38.848.
   Study of positioning in Rel-19 is RAN3-led, limited to functionalities which would have no, or minimal, specification impact (note: this does not imply any decision relating to WI creation).
   Study the feasibility and required functionalities for proximity determination (coordination with SA3 is required for privacy aspects).
      RAN1-led:
      For the Ambient IoT DL and UL:
         Frame structure, synchronization and timing, random access
         Numerologies, bandwidths, and multiple access
         Waveforms and modulations
         Channel coding
         Downlink channel/signal aspects
         Uplink channel/signal aspects
         Scheduling and timing relationships
         Study necessary characteristics of carrier-wave waveform for a carrier wave provided externally to the Ambient IoT device, including for interference handling at Ambient IoT UL receiver, and at NR basestation.
         For Topology 2, no difference in physical layer design from Topology 1.
      RAN2-led:
         Study and decide which functions are needed for an Ambient IoT compact protocol stack and lightweight signalling procedure to enable DO-DTT and DT data transmission, and study those functions.
         For example:
         Paging
         Random access
         Data transmission, including necessary radio resource control aspects, respecting the limitation in the General Scope
         Interactions with upper layers
         For functionalities not listed above, they are studied only if found essential.

### **************************************Quotation End**************************************

The description (e.g., regarding scenario, topology and assumption) for ambient IoT could be found in TR 38.848 ([2] 3GPP TR 38.848 V18.0.0 (2023-09) 3GPP), as provided below:

### **************************************Quotation Start [2]**************************************

### 4.2.1 Connectivity Topologies

### 4.2.1.0 Introduction

The following connectivity topologies for Ambient IoT networks and devices are defined for the purposes of the study. In all these topologies, the Ambient IoT device may be provided with a carrier wave from other node(s) either inside or outside the topology. The links in each topology may be bidirectional or unidirectional.

BS, UE, assisting node, or intermediate node could be multiple BSs or UEs, respectively. The mixture of indoor and outdoor placement of such nodes is regarded as a network implementation choice. Account would need to be taken of potential impact on device or node complexity. In the connectivity topologies, this does not imply the existence of multi-hop assisting or intermediate nodes.

### 4.2.1.1 Topology 1: BS↔Ambient IoT Device

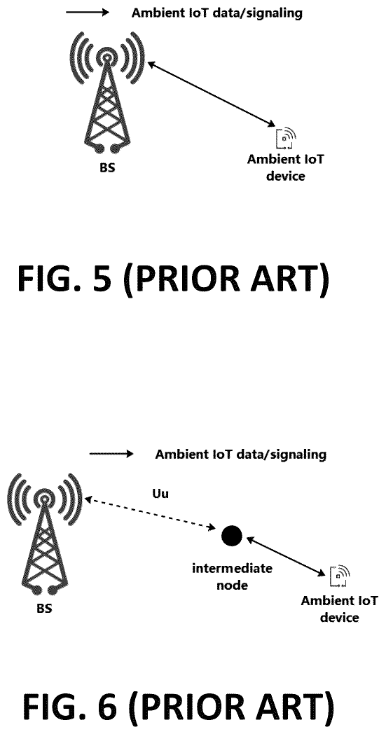

FIG. 5 is a reproduction of Figure 4.2.1.1-1: Topology 1, from 3GPP TR 38.848 V18.0.0.

In Topology 1, the Ambient IoT device directly and bidirectionally communicates with a basestation. The communication between the basestation and the ambient IoT device includes Ambient IoT data and/or signalling. This topology includes the possibility that the BS transmitting to the Ambient IoT device is a different from the BS receiving from the Ambient IoT device.

### 4.2.1.2 Topology 2: BS↔Intermediate Node↔Ambient IoT Device

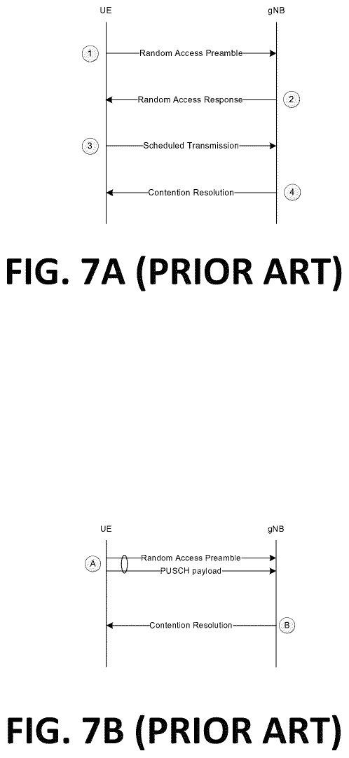

FIG. 6 is a reproduction of Figure 4.2.1.2-1: Topology 2, from 3GPP TR 38.848 V18.0.0.

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### **************************************Next Quotation**************************************

### 4.2.2 Deployment Scenarios

### 4.2.2.1 Deployment Scenario 1: Device Indoors, Basestation Indoors

With Ambient IoT device indoors and basestation indoors, this deployment scenario is characterized according to Table 4.2.2.1-1.

TABLE 4.2.2.1-1
Characteristics of deployment scenario 1

| Applicable representative | | |
|---|---|---|
| use cases | Characteristics | Description (NOTE 1) |
| Indoor inventory | Environment (of device) | Indoor |
| Indoor sensor | Basestation characteristic (if any) | Micro- or pico-cell |
| Indoor positioning | Connectivity topology | Topology (1), (2), (3) |
| Indoor command | Spectrum | Licensed FDD, licensed TDD, |
| | | unlicensed |
| | Coexistence with existing 3GPP | Co-site or new site |
| | technologies | |
| | Traffic assumption | DT and DO |
| | Device characteristic | Device A or Device B or Device C |

NOTE 1:
Descriptions may not be applicable for some Devices (A, B).

### 4.2.2.2 Deployment Scenario 2: Device Indoors, Basestation Outdoors

With Ambient IoT device indoors and basestation outdoors, this deployment scenario is characterized according to Table 4.2.2.2-1.

TABLE 4.2.2.2-1
Characteristics of deployment scenario 2

| Applicable representative | | |
|---|---|---|
| use cases | Characteristics | Description (NOTE 1) |
| Indoor inventory | Environment (of device) | Indoor |
| Indoor sensor | Basestation characteristic (if any) | Macro- or Micro- cell BS |
| Indoor positioning | Connectivity topology | Topology (1), (2), (3) |
| Indoor command | | Note: The location of intermediate or |
| | | assisting node (if any) is indoor or |
| | | outdoor |
| | Spectrum | Licensed FDD, licensed TDD, |
| | | unlicensed |
| | Coexistence with existing 3GPP | Co-site or new site |
| | technologies | |
| | Traffic assumption | DT and DO |
| | Device characteristic | Device C may support Topology (1), |
| | | (2), (3), |
| | | Device A may support Topology (2), |
| | | Device B may support Topology (2), |
| | | (3) |

### Next Quotation

### 4.3 Device Categorization

Ambient IoT devices are characterized in the study according to their energy storage capacity, and capability of generating RF signals for their transmissions.

The study considers that a device has either:
No energy storage at all; or
Limited energy storage

Relying on these storage capacities, the study considers the following set of Ambient IoT devices:
Device A: No energy storage, no independent signal generation/amplification, i.e. backscattering transmission.
Device B: Has energy storage, no independent signal generation, i.e. backscattering transmission. Use of stored energy can include amplification for reflected signals.
Device C: Has energy storage, has independent signal generation, i.e., active RF components for transmission.

A limited energy storage can be different among implementations within Device B or implementations within Device C, and different between Device B and Device C. Such storage is expected to be order(s) of magnitude smaller than an NB-IoT device would typically include.

### **************************************Quotation End**************************************

The current random access (RA) procedure is specified in TS 38.321 ([3] 3GPP TS 38.321 V17.6.0 (2023-09) 3GPP). A current RA procedure would be performed by a legacy UE.

### **************************************Quotation Start [3]**************************************

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [4]. There is only one Random Access procedure ongoing at any point in time in a MAC entity. The Random Access procedure on an SCell shall only be initiated by a PDCCH order with ra-PreambleIndex different from 0b000000.
. . .

When a Random Access procedure is initiated, UE selects a set of Random Access resources as specified in clause 5.1.1b and initialises the following parameters for the Random Access procedure according to the values configured by RRC for the selected set of Random Access resources:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
. . .
msgA-PRACH-ConfigurationIndex: the available set of PRACH occasions for the transmission of the Random Access Preamble for MSGA in 2-step RA type;
preambleReceivedTargetPower: initial Random Access Preamble power for 4-step RA type;
msgA-PreambleReceivedTargetPower: initial Random Access Preamble power for 2-step RA type;
rsrp-ThresholdSSB: an RSRP threshold for the selection of the SSB for 4-step RA type. If the Random Access procedure is initiated for beam failure recovery, rsrp-ThresholdSSB used for the selection of the SSB within candidate BeamRSList refers to rsrp-ThresholdSSB in BeamFailureRecoveryConfig IE;
rsrp-ThresholdCSI-RS: an RSRP threshold for the selection of CSI-RS for 4-step RA type. If the Random Access procedure is initiated for beam failure recovery, rsrp-ThresholdCSI-RS is equal to rsrp-ThresholdSSB in BeamFailureRecoveryConfig IE;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
rsrp-ThresholdMsg3: an RSRP threshold for Msg3 repetition (see clause 5.1.1b);
FeatureCombination: feature or a combination of features associated with a set of Random Access resources;
feature Priorities: priorities for features, such as RedCap, Slicing, etc. (see clause 5.1.1d);
msgA-TransMax: The maximum number of MSGA transmissions when both 4-step and 2-step RA type Random Access Resources are configured;
candidate BeamRSList: a list of reference signals (CSI-RS and/or SSB) identifying the candidate beams for recovery and the associated Random Access parameters;
recoverySearchSpaceId: the search space identity for monitoring the response of the beam failure recovery request;
powerRampingStep: the power-ramping factor;
msgA-PreamblePowerRampingStep: the power ramping factor for MSGA preamble;
powerRampingStepHighPriority: the power-ramping factor in case of prioritized Random Access procedure;
1 scalingFactorBI: a scaling factor for prioritized Random Access procedure;
ra-PreambleIndex: Random Access Preamble;
ra-ssb-OccasionMaskIndex: defines PRACH occasion(s) associated with an SSB in which the MAC entity may transmit a Random Access Preamble (see clause 7.4);
msgA-SSB-SharedRO-MaskIndex: Indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-MaskIndex is not configured, then all 4-step RA type PRACH occasions are available for 2-step RA type (see clause 7.4);
ssb-SharedRO-MaskIndex: defines PRACH occasions, on which preambles are allocated for a feature or a combination of features, associated with an SSB in which the MAC entity may transmit a Random Access Preamble (see clause 7.4);
ra-Occasion List: defines PRACH occasion(s) associated with a CSI-RS in which the MAC entity may transmit a Random Access Preamble;
ra-PreambleStartIndex: the starting index of Random Access Preamble(s) for on-demand SI request;
startPreambleForThisPartition: the first preamble associated with the set of Random Access Resources applicable to the Random Access procedure;
preambleTransMax: the maximum number of Random Access Preamble transmission;
ssb-perRACH-OccasionAndCB-PreamblesPerSSB: defines the number of SSBs mapped to each PRACH occasion for 4-step RA type and the number of contention-based Random Access Preambles mapped to each SSB;
msgA-CB-PreamblesPerSSB-PerSharedRO: defines the number of contention-based Random Access Preambles for 2-step RA type mapped to each SSB when the PRACH occasions are shared between 2-step and 4-step RA types;
msgA-SSB-PerRACH-OccasionAndCB-PreamblesPerSSB: defines the number of SSBs mapped to each PRACH occasion for 2-step RA type and the number of contention-based Random Access Preambles mapped to each SSB;
numberOfPreamblesPerSSB-ForThisPartition: defines the number of consecutive preambles for a feature or a combination of features mapped to each SSB;
msgA-PUSCH-ResourceGroupA: defines MSGA PUSCH resources that the UE shall use when performing MSGA transmission using Random Access Preambles group A;
msgA-PUSCH-ResourceGroupB: defines MSGA PUSCH resources that the UE shall use when performing MSGA transmission using Random Access Preambles group B;
msgA-PUSCH-Resource-Index: identifies the index of the PUSCH resource used for MSGA in case of contention-free Random Access with 2-step RA type;
. . .
ra-ResponseWindow: the time window to monitor RA response(s) (SpCell only);
ra-ContentionResolutionTimer: the Contention Resolution Timer (SpCell only);
msgB-ResponseWindow: the time window to monitor RA response(s) for 2-step RA type (SpCell only).
   . . .

When the Random Access procedure is initiated on a Serving Cell, the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;
1> set POWER_OFFSET_2STEP_RA to 0 dB;
. . .
1> perform the BWP operation as specified in clause 5.15;
1> select the set of Random Access resources applicable to the current Random Access procedure according to clause 5.1.1b;
1> if the Random Access procedure is initiated by PDCCH order and if the ra-PreambleIndex explicitly provided by PDCCH is not 0b000000; or
1> if the Random Access procedure was initiated for SI request (as specified in TS 38.331 [5]) and the Random Access Resources for SI request have been explicitly provided by RRC; or
. . .
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA_TYPE to 4-stepRA.
1> else if the BWP selected for Random Access procedure is configured with both 2-step and 4-step RA type Random Access Resources within the selected set of Random Access resources (as specified in clause 5.1.1b) and the RSRP of the downlink pathloss reference is above msgA-RSRP-Threshold; or
1> if the BWP selected for Random Access procedure is only configured with 2-step RA type Random Access resources within the selected set of Random Access resources according to clause 5.1.1b; or
1> if the Random Access procedure was initiated for reconfiguration with sync and if the contention-free Random Access Resources for 2-step RA type have been explicitly provided in rach-ConfigDedicated for the BWP selected for Random Access procedure:
   2> set the RA_TYPE to 2-stepRA.
1> else:
   2> set the RA_TYPE to 4-stepRA.
1> perform initialization of variables specific to Random Access type as specified in clause 5.1.1a;
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).
      5.1.1a Initialization of variables specific to Random Access type

The MAC entity shall:
1> if RA_TYPE is set to 2-stepRA:
   2> set PREAMBLE_POWER_RAMPING_STEP to msgA-PreamblePowerRampingStep;
   2> set SCALING_FACTOR_BI to 1;
   2> apply preambleTransMax included in the RACH-ConfigGenericTwoStepRA;
   . . .
   2> set MSGA_PREAMBLE_POWER_RAMPING_STEP to PREAMBLE_POWER_RAMPING_STEP.
1> else (i.e. RA_TYPE is set to 4-stepRA):
   2> set PREAMBLE_POWER_RAMPING_STEP to powerRampingStep;
   2> set SCALING_FACTOR_BI to 1;
   2> set preambleTransMax to preambleTransMax included in the RACH-ConfigGeneric;

### 5.1.1b Selection of the Set of Random Access Resources for the Random Access Procedure

The MAC entity shall:
1> if the BWP selected for Random Access procedure is configured with both set(s) of Random Access resources with msg3-Repetitions set to true and set(s) of Random Access resources without msg3-Repetitions set to true and the RSRP of the downlink pathloss reference is less than rsrp-ThresholdMsg3; or
1> if the BWP selected for Random Access procedure is only configured with the set(s) of Random Access resources with msg3-Repetitions set to true:
   2> assume Msg3 repetition is applicable for the current Random Access procedure.
1> else:
   2> assume Msg3 repetition is not applicable for the current Random Access procedure.
. . .
   1> if neither contention-free Random Access Resources nor Random Access Resources for SI request have been provided for this Random Access procedure and one or more of the features including RedCap and/or Slicing and/or SDT and/or MSG3 repetition is applicable for this Random Access procedure:
. . .
   2> if none of the sets of Random Access resources are available for any feature applicable to the current Random Access procedure (as specified in clause 5.1.1c):
      3> select the set(s) of Random Access resources that are not associated with any feature indication (as specified in clause 5.1.1c) for this Random Access procedure.
   2> else if there is one set of Random Access resources available which can be used for indicating all features triggering this Random Access procedure:
      3> select this set of Random Access resources for this Random Access procedure.
   2> else (i.e. there are one or more sets of Random Access resources available that are configured with indication(s) for a subset of all features triggering this Random Access procedure):
      3> select a set of Random Access resources from the available set(s) of Random Access resources based on the priority order indicated by upper layers as specified in clause 5.1.1d for this Random Access Procedure.
1> else if contention-free Random Access Resources have been provided for this Random Access procedure and RedCap is applicable for the current Random Access procedure and there is one set of Random Access resources available that is only configured with RedCap indication:
   2> select this set of Random Access resources for this Random Access procedure.
1> else:
   2> select the set of Random Access resources that are not associated with any feature indication (as specified in clause 5.1.1c) for the current Random Access procedure.

### 5.1.1c Availability of the Set of Random Access Resources

The MAC entity shall for each set of configured Random Access resources for 4-step RA type and for each set of configured Random Access resources for 2-step RA type:
1> if redCap is set to true for a set of Random Access resources:
   2> consider the set of Random Access resources as not available for a Random Access procedure for which RedCap is not applicable.
1> if smallData is set to true for a set of Random Access resources:
   2> consider the set of Random Access resources as not available for the Random Access procedure which is not triggered for RA-SDT.
1> if NSAG-List is configured for a set of Random Access resources:
   2> consider the set of Random Access resources as not available for the Random Access procedure unless it is triggered for any one of the NSAG-ID(s) in the NSAG-List.
1> if msg3-Repetitions is set to true for a set of Random Access resources:
   2> consider the set of Random Access resources as not available for the Random Access procedure if Msg3 repetition is not applicable.
1> if a set of Random Access resources is not configured with FeatureCombination:
   2> consider the set of Random Access resources to not associated with any feature.

### 5.1.2 Random Access Resource Selection

If the selected RA_TYPE is set to 4-stepRA, the MAC entity shall:
. . .
1> else if the ra-PreambleIndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH.
1> else if the contention-free Random Access Resources associated with SSBs have been explicitly provided in rach-ConfigDedicated and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_INDEX to a ra-PreambleIndex corresponding to the selected SSB.
1> else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs;
   2> set the PREAMBLE_INDEX to a ra-PreambleIndex corresponding to the selected CSI-RS.
. . .
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
. . .
   2> select a Random Access Preamble randomly with equal probability from the Random Access Preambles associated with the selected SSB and the selected Random Access Preambles group;
   2> set the PREAMBLE_INDEX to the selected Random Access Preamble.
. . .
1> else if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB).
1> else if a CSI-RS is selected above:
   2> if there is no contention-free Random Access Resource associated with the selected CSI-RS:
      3> determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS as specified in TS 38.214 (the MAC entity shall select a PRACH occasion randomly with equal probability amongst the consecutive PRACH occasions according to clause 8.1 of TS 38.213 [6] regardless the FR2 UL gap, corresponding to the SSB which is quasi-colocated with the selected CSI-RS; the MAC entity may take into account the possible occurrence of measurement gaps and MUSIM gaps when determining the next available PRACH occasion corresponding to the SSB which is quasi-colocated with the selected CSI-RS).
   2> else:
      3> determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers regardless the FR2 UL gap, corresponding to the selected CSI-RS; the MAC entity may take into account the possible occurrence of measurement gaps and MUSIM gaps when determining the next available PRACH occasion corresponding to the selected CSI-RS).
1> perform the Random Access Preamble transmission procedure (see clause 5.1.3).
. . .

### 5.1.2a Random Access Resource Selection for 2-Step RA Type

If the selected RA_TYPE is set to 2-stepRA, the MAC entity shall:
1> if the contention-free 2-step RA type Resources associated with SSBs have been explicitly provided in rach-Config Dedicated and at least one SSB with SS-RSRP above msgA-RSRP-ThresholdSSB amongst the associated SSBs is available:
   2> select an SSB with SS-RSRP above msgA-RSRP-ThresholdSSB amongst the associated SSBs;
   2> set the PREAMBLE_INDEX to a ra-PreambleIndex corresponding to the selected SSB.
1> else (i.e. for the contention-based Random Access Preamble selection):
   2> if at least one of the SSBs with SS-RSRP above msgA-RSRP-ThresholdSSB is available:
      3> select an SSB with SS-RSRP above msgA-RSRP-ThresholdSSB.
   2> else:
      3> select any SSB.
   . . .
   2> select a Random Access Preamble randomly with equal probability from the 2-step RA type Random Access Preambles associated with the selected SSB and the selected Random Access Preambles group;
   2> set the PREAMBLE_INDEX to the selected Random Access Preamble.
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured (the MAC entity shall select a PRACH occasion randomly with equal probability among the consecutive PRACH occasions allocated for 2-step RA type according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB);
1> if the Random Access Preamble was not selected by the MAC entity among the contention-based Random Access Preamble(s):
   2> select a PUSCH occasion from the PUSCH occasions configured in msgA-CFRA-PUSCH corresponding to the PRACH slot of the selected PRACH occasion, according to msgA-PUSCH-Resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion according to clause 8.1A of TS 38.213 [6];
   2> determine the UL grant for the MSGA payload according to the PUSCH configuration associated with the selected Random Access Preambles group and determine the associated HARQ information;
   2> if the selected preamble and PRACH occasion is mapped to a valid PUSCH occasion as specified in clause 8.1A of TS 38.213 [6]:
      3> deliver the UL grant and the associated HARQ information to the HARQ entity.
1> perform the MSGA transmission procedure (see clause 5.1.3a).
. . .
   5.1.3 Random Access Preamble transmission

The MAC entity shall, for each Random Access Preamble:
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
. . .

### 5.1.3a MSGA Transmission

The MAC entity shall, for each MSGA:
. . .
1> if this is the first MSGA transmission within this Random Access procedure:
   2> if the transmission is not being made for the CCCH logical channel:
      3> indicate to the Multiplexing and assembly entity to include a C-RNTI MAC CE in the subsequent uplink transmission.
      . . .
   2> obtain the MAC PDU to transmit from the Multiplexing and assembly entity according to the HARQ information determined for the MSGA payload (see clause 5.1.2a) and store it in the MSGA buffer.
1> compute the MSGB-RNTI associated with the PRACH occasion in which the Random Access Preamble is transmitted;
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (i.e. (PREAMBLE_POWER_RAMPING_COUNTER−1)×PREAMBLE_POWER_RAMPING_STEP);
. . .
NOTE: The MSGA transmission includes the transmission of the PRACH Preamble as well as the contents of the MSGA buffer in the PUSCH resource corresponding to the selected PRACH occasion and PREAMBLE_INDEX (see TS 38.213 [6])

### 5.1.4 Random Access Response Reception

Once the Random Access Preamble is transmitted and regardless of the possible occurrence of a measurement gap, the MAC entity shall:
. . .
   3> start the ra-Response Window configured in RACH-ConfigCommon at the first PDCCH occasion as specified in TS 38.213 [6] from the end of the Random Access Preamble transmission.
      2> monitor the PDCCH of the SpCell for Random Access Response(s) identified by the RA-RNTI while the ra-ResponseWindow is running.
1> if notification of a reception of a PDCCH transmission on the search space indicated by recoverySearchSpaceId is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213 [6]) downlink assignment has been received on the PDCCH for the RA-RNTI and the received TB is successfully decoded:
   2> if the Random Access Response contains a MAC subPDU with Backoff Indicator:
      3> set the PREAMBLE_BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
      3> else:
         4> apply the following actions for the Serving Cell where the Random Access Preamble was transmitted:
         . . .
         6> process the received UL grant value and indicate it to the lower layers.
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> obtain the MAC PDU to transmit from the Multiplexing and assembly entity and store it in the Msg3 buffer.
. . .
1> if ra-Response Window configured in RACH-ConfigCommon expires, and if the Random Access Response containing Random Access Preamble identifiers that matches the transmitted PREAMBLE_INDEX has not been received:
   2> consider the Random Access Response reception not successful;
   2> increment PREAMBLE_TRANSMISSION_COUNTER by 1;
   2> if PREAMBLE_TRANSMISSION_COUNTER=preambleTransMax+1:
      3> if the Random Access Preamble is transmitted on the SpCell:
         4> indicate a Random Access problem to upper layers;
         4> if this Random Access procedure was triggered for SI request:
         5> consider the Random Access procedure unsuccessfully completed.
      3> else if the Random Access Preamble is transmitted on an SCell:
         4> consider the Random Access procedure unsuccessfully completed.
   2> if the Random Access procedure is not completed:
      3> select a random backoff time according to a uniform distribution between 0 and the PREAMBLE_BACKOFF;
      3> if the criteria (as defined in clause 5.1.2) to select contention-free Random Access Resources is met during the backoff time:
         4> perform the Random Access Resource selection procedure (see clause 5.1.2).
      3> else if the Random Access procedure for an SCell is performed on uplink carrier where pusch-Config is not configured:
         4> delay the subsequent Random Access transmission until the Random Access Procedure is triggered by a PDCCH order with the same ra-PreambleIndex, ra-ssb-OccasionMaskIndex, and UL/SUL indicator TS 38.212.
      3> else:
         4> perform the Random Access Resource selection procedure (see clause 5.1.2) after the backoff time.

The MAC entity may stop ra-Response Window (and hence monitoring for Random Access Response(s)) after successful reception of a Random Access Response containing Random Access Preamble identifiers that matches the transmitted PREAMBLE_INDEX.

. . .

### 5.1.4a MSGB Reception and Contention Resolution for 2-Step RA Type

Once the MSGA preamble is transmitted, regardless of the possible occurrence of a measurement gap, the MAC entity shall:
1> start the msgB-Response Window at the PDCCH occasion as specified in TS 38.213 [6], clause 8.2A;
1> monitor the PDCCH of the SpCell for a Random Access Response identified by MSGB-RNTI while the msgB-Response Window is running;
1> if C-RNTI MAC CE was included in the MSGA:
   2> monitor the PDCCH of the SpCell for Random Access Response identified by the C-RNTI while the msgB-Response Window is running.
1> if notification of a reception of a PDCCH transmission of the SpCell is received from lower layers:
   2> if the C-RNTI MAC CE was included in MSGA:
      . . .
      3> else if the timeAlignmentTimer associated with the PTAG is running; or
      3> if CG-SDT procedure is ongoing and cg-SDT-TimeAlignmentTimer is running:
         4> if the PDCCH transmission is addressed to the C-RNTI and contains a UL grant for a new transmission:
         5> consider this Random Access Response reception successful;
         5> stop the msgB-ResponseWindow;
         5> consider this Random Access procedure successfully completed.
      3> else:
         4> if a downlink assignment has been received on the PDCCH for the C-RNTI and the received TB is successfully decoded:
         5> if the MAC PDU contains the Absolute Timing Advance Command MAC CE:
         6> process the received Timing Advance Command (see clause 5.2);
         6> consider this Random Access Response reception successful;
         6> stop the msgB-Response Window;
         6> consider this Random Access procedure successfully completed and finish the disassembly and demultiplexing of the MAC PDU.
   2> if a valid (as specified in TS 38.213 [6]) downlink assignment has been received on the PDCCH for the MSGB-RNTI and the received TB is successfully decoded:
      3> if the MSGB contains a MAC subPDU with Backoff Indicator:
         4> set the PREAMBLE_BACKOFF to value of the BI field of the MAC subPDU using Table 7.2-1, multiplied with SCALING_FACTOR_BI.
      3> else:
         4> set the PREAMBLE_BACKOFF to 0 ms.
      3> if the MSGB contains a fallbackRAR MAC subPDU; and
      3> if the Random Access Preamble identifier in the MAC subPDU matches the transmitted PREAMBLE_INDEX (see clause 5.1.3a):
         4> consider this Random Access Response reception successful;
         4> apply the following actions for the SpCell:
         . . .
         5> if the Random Access Preamble was not selected by the MAC entity among the contention-based Random Access Preamble(s):
         6> consider the Random Access procedure successfully completed;
         6> process the received UL grant value and indicate it to the lower layers.
         5> else:
         6> set the TEMPORARY_C-RNTI to the value received in the Random Access Response;
         6> if the Msg3 buffer is empty:
         7> obtain the MAC PDU to transmit from the MSGA buffer and store it in the Msg3 buffer;
         6> process the received UL grant value and indicate it to the lower layers and proceed with Msg3 transmission.
   . . .
      3> else if the MSGB contains a successRAR MAC subPDU; and
      3> if the CCCH SDU was included in the MSGA and the UE Contention Resolution Identity in the MAC subPDU matches the CCCH SDU:
         4> stop msgB-Response Window;
         . . .
         5> set the C-RNTI to the value received in the successRAR;
         5> apply the following actions for the SpCell:
         6> process the received Timing Advance Command (see clause 5.2);
         6> indicate the msgA-PreambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP).
         . . .
         4> consider this Random Access Response reception successful;
         4> consider this Random Access procedure successfully completed;
         4> finish the disassembly and demultiplexing of the MAC PDU.
1> if msgB-ResponseWindow expires, and the Random Access Response Reception has not been considered as successful based on descriptions above:
   2> increment PREAMBLE_TRANSMISSION_COUNTER by 1;
   2> if PREAMBLE_TRANSMISSION_COUNTER=preambleTransMax+1:
      3> indicate a Random Access problem to upper layers;
      3> if this Random Access procedure was triggered for SI request:
         4> consider this Random Access procedure unsuccessfully completed.
   2> if the Random Access procedure is not completed:
      3> if msgA-TransMax is applied (see clause 5.1.1a) and PREAMBLE_TRANSMISSION_COUNTER=msgA-TransMax+1:
         4> set the RA_TYPE to 4-stepRA;
         4> perform initialization of variables specific to Random Access type as specified in clause 5.1.1a;
         4> if the Msg3 buffer is empty:
         5> obtain the MAC PDU to transmit from the MSGA buffer and store it in the Msg3 buffer;
         4> flush HARQ buffer used for the transmission of MAC PDU in the MSGA buffer;
         4> discard explicitly signalled contention-free 2-step RA type Random Access Resources, if any;
         4> perform the Random Access Resource selection procedure as specified in clause 5.1.2.
      3> else:
         4> select a random backoff time according to a uniform distribution between 0 and the PREAMBLE_BACKOFF;
         4> if the criteria (as defined in clause 5.1.2a) to select contention-free Random Access Resources is met during the backoff time:
         5> perform the Random Access Resource selection procedure for 2-step RA type Random Access (see clause 5.1.2a).
         4> else:
         5> perform the Random Access Resource selection procedure for 2-step RA type Random Access (see clause 5.1.2a) after the backoff time.

Upon receiving a fallbackRAR, the MAC entity may stop msgB-ResponseWindow once the Random Access Response reception is considered as successful.

### 5.1.5 Contention Resolution

Once Msg3 is transmitted the MAC entity shall:
1> if the Msg3 transmission (i.e. initial transmission or HARQ retransmission) is scheduled with PUSCH repetition Type A:
   . . .
      3> start or restart the ra-ContentionResolutionTimer in the first symbol after the end of all repetitions of the Msg3 transmission.
   . . .
1> else:
   2> start or restart the ra-ContentionResolutionTimer in the first symbol after the end of the Msg3 transmission.
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      . . .
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         . . .
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.
1> if ra-ContentionResolutionTimer expires:
   . . .
      3> discard the TEMPORARY_C-RNTI;
      3> consider the Contention Resolution not successful.
1> if the Contention Resolution is considered not successful:
   2> flush the HARQ buffer used for transmission of the MAC PDU in the Msg3 buffer;
   2> increment PREAMBLE_TRANSMISSION_COUNTER by 1;
   2> if PREAMBLE_TRANSMISSION_COUNTER=preambleTransMax+1:
      3> indicate a Random Access problem to upper layers.
      . . .
   2> if the Random Access procedure is not completed:
      3> if the RA_TYPE is set to 4-stepRA:
         4> select a random backoff time according to a uniform distribution between 0 and the PREAMBLE_BACKOFF;
         4> if the criteria (as defined in clause 5.1.2) to select contention-free Random Access Resources is met during the backoff time:
         5> perform the Random Access Resource selection procedure (see clause 5.1.2);
         4> else:
         5> perform the Random Access Resource selection procedure (see clause 5.1.2) after the backoff time.
      3> else (i.e. the RA_TYPE is set to 2-stepRA):
         4> if msgA-TransMax is applied (see clause 5.1.1a) and PREAMBLE_TRANSMISSION_COUNTER=msgA-TransMax+1:
         5> set the RA_TYPE to 4-stepRA;
         5> perform initialization of variables specific to Random Access type as specified in clause 5.1.1a;
         5> flush HARQ buffer used for the transmission of MAC PDU in the MSGA buffer;
         5> discard explicitly signalled contention-free 2-step RA type Random Access Resources, if any;
         5> perform the Random Access Resource selection as specified in clause 5.1.2.
         4> else:
         5> select a random backoff time according to a uniform distribution between 0 and the PREAMBLE_BACKOFF;
         5> if the criteria (as defined in clause 5.1.2a) to select contention-free Random Access Resources is met during the backoff time:
         6> perform the Random Access Resource selection procedure for 2-step RA type as specified in clause 5.1.2a.
         5> else:
         6> perform the Random Access Resource selection for 2-step RA type procedure (see clause 5.1.2a) after the backoff time.

### 5.1.6 Completion of the Random Access Procedure

Upon completion of the Random Access procedure, the MAC entity shall:
1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.

### **************************************Next Quotation**************************************

### 5.15 Bandwidth Part (BWP) Operation

### 5.15.1 Downlink and Uplink

. . .

Upon initiation of the Random Access procedure on a Serving Cell, after the selection of carrier for performing Random Access procedure as specified in clause 5.1.1, the MAC entity shall for the selected carrier of this Serving Cell:
1> if PRACH occasions are not configured for the active UL BWP:
   . . .
      3> switch the active UL BWP to BWP indicated by initialUplinkBWP.
   2> if the Serving Cell is an SpCell:
      . . .
         4> switch the active DL BWP to BWP indicated by initialDownlinkBWP.
1> else:
   2> if the Serving Cell is an SpCell:
      3> if the active DL BWP does not have the same bwp-Id as the active UL BWP:
         4> switch the active DL BWP to the DL BWP with the same bwp-Id as the active UL BWP.
. . .
1> perform the Random Access procedure on the active DL BWP of SpCell and active UL BWP of this Serving Cell.

### **************************************Quotation End**************************************

The general description of random access procedure is specified in TS 38.300 ([4] 3GPP TS 38.300 V17.6.0 (2023-09) 3GPP):

### **************************************Quotation Start [4]**************************************

### 9.2.6 Random Access Procedure

. . .

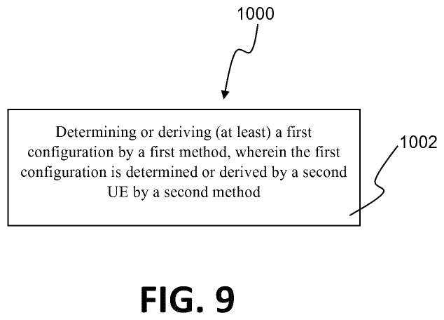

Two types of random access procedure are supported: 4-step RA type with MSG1 and 2-step RA type with MSGA. Both types of RA procedure support contention-based random access (CBRA) and contention-free random access (CFRA) as shown on Figure 9.2.6-1 below.

The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.

The network does not configure CFRA resources for 4-step and 2-step RA types at the same time for a Bandwidth Part (BWP). CFRA with 2-step RA type is only supported for handover.

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as shown in Figure 9.2.6-1(c). For CBRA, upon reception of the random access response, the UE sends MSG3 using the UL grant scheduled in the response and monitors contention resolution as shown in Figure 9.2.6-1(a). If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in Figure 9.2.6-1(d). For CBRA, if contention resolution is successful upon receiving the network response, the UE ends the random access procedure as shown in Figure 9.2.6-1(b); while if fallback indication is received in MSGB, the UE performs MSG3 transmission using the UL grant scheduled in the fallback indication and monitors contention resolution as shown in Figure 9.2.6-2. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

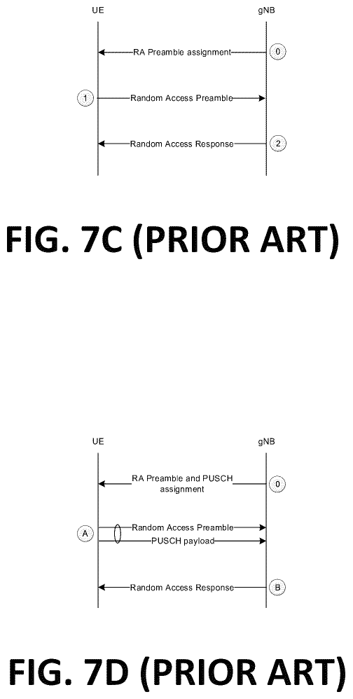

FIG. 7A is a reproduction of Figure 9.2.6-1(a): Random Access Procedures, CBRA with 4-step RA type, from 3GPP TS 38.300 V17.6.0.

FIG. 7B is a reproduction of Figure 9.2.6-1(b): Random Access Procedures, CBRA with 2-step RA type, from 3GPP TS 38.300 V17.6.0.

FIG. 7C is a reproduction of Figure 9.2.6-1(c): Random Access Procedures, CFRA with 4-step RA type, from 3GPP TS 38.300 V17.6.0.

FIG. 7D is a reproduction of Figure 9.2.6-1(d): Random Access Procedures, CFRA with 2-step RA type, from 3GPP TS 38.300 V17.6.0.

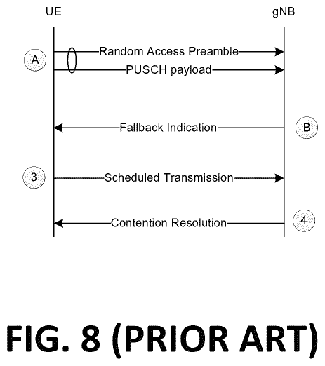

FIG. 8 is a reproduction of Figure 9.2.6-2: Fallback for CBRA with 2-step RA type, from 3GPP TS 38.300 V17.6.0.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

### **************************************Quotation End**************************************

Some configurations related to access procedure, BWP and SDT in current standard are specified in TS 38.331 ([5] 3GPP TS 38.331 V17.6.0 (2023-09) 3GPP):

```
************************************** Quotation Start **********************************
- Paging
The Paging message is used for the notification of one or more UEs.
  ...
  Direction: Network to UE
```

| | |
|---|---|
| | Paging message |
| Paging ::= | SEQUENCE { |
| pagingRecordList | PagingRecordList |

OPTIONAL, -- Need N
...

| | |
|---|---|
| nonCriticalExtension | Paging-v1700-IEs |

OPTIONAL
}

| | |
|---|---|
| Paging-v1700-IEs ::= | SEQUENCE { |
| pagingRecordList-v1700 | PagingRecordList-v1700 |

OPTIONAL, -- Need N
...
}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF PagingRecord-v1700 |

...

| PagingRecord ::= | SEQUENCE { | |
|---|---|---|
| ue-Identity | PagingUE-Identity, | |
| accessType | ENUMERATED {non3GPP} | OPTIONAL, -- Need N |

...
}

| PagingRecord-v1700 ::= | SEQUENCE { | |
|---|---|---|
| pagingCause-r17 | ENUMERATED {voice} | OPTIONAL -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}

PagingRecord field descriptions

accessType
Indicates whether the Paging message is originated due to the PDU sessions from the non-3GPP access.
pagingCause
Indicates whether the Paging message is originated due to IMS voice. If this field is present, it implies that the
corresponding paging entry is for IMS voice. If upper layers indicate the support of paging cause and if this field is not
present but pagingRecordList-v1700 is present, it implies that the corresponding paging entry is for a service other than
IMS voice. Otherwise, paging cause is undetermined.

### RRCRelease

The RRCRelease message is used to command the release of an RRC connection or the suspension of the RRC connection.
. . .
Direction: Network to UE

RRCRelease message

...

| | |
|---|---|
| RRCRelease-IEs ::= | SEQUENCE { |

...

| | |
|---|---|
| suspendConfig | SuspendConfig |

OPTIONAL, -- Need R
...
}
...

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |

...

| | |
|---|---|
| sdt-Config-r17 | SetupRelease { SDT-Config-r17 } |

OPTIONAL, -- Need M
...
}
...

| | |
|---|---|
| PagingCycle ::= | ENUMERATED {rf32, rf64, rf128, rf256} |

...

| | |
|---|---|
| SDT-Config-r17 ::= | SEQUENCE { |

...

| | |
|---|---|
| sdt-MAC-PHY-CG-Config-r17 | SetupRelease {SDT-CG-Config-r17} |

OPTIONAL, -- Need M

| | |
|---|---|
| sdt-DRB-ContinueROHC-r17 | ENUMERATED { cell, rna } |

OPTIONAL -- Need S
}
SDT-CG-Config-r17 ::= OCTET STRING (CONTAINING SDT-MAC-PHY-CG-Config-r17)

| | |
|---|---|
| SDT-MAC-PHY-CG-Config-r17 ::= | SEQUENCE { |

...

| | |
|---|---|
| cg-SDT-ConfigInitialBWP-NUL-r17 | SetupRelease {BWP-UplinkDedicatedSDT-r17} |

OPTIONAL, -- Need M

| | |
|---|---|
| cg-SDT-ConfigInitialBWP-SUL-r17 | SetupRelease {BWP-UplinkDedicatedSDT-r17} |

OPTIONAL, -- Need M

| | |
|---|---|
| cg-SDT-ConfigInitialBWP-DL-r17 | BWP-DownlinkDedicatedSDT-r17 |

OPTIONAL, -- Need M
...

| | |
|---|---|
| cg-SDT-CS-RNTI-r17 | RNTI-Value |

OPTIONAL, -- Need M
...
}
...

| | |
|---|---|
| BWP-DownlinkDedicatedSDT-r17 ::= | SEQUENCE { |
| pdcch-Config-r17 | SetupRelease { PDCCH-Config } |

OPTIONAL, -- Need M

| | |
|---|---|
| pdsch-Config-r17 | SetupRelease { PDSCH-Config } |

OPTIONAL, -- Need M
...
}

| | |
|---|---|
| BWP-UplinkDedicatedSDT-r17 ::= | SEQUENCE { |
| pusch-Config-r17 | SetupRelease { PUSCH-Config } |

OPTIONAL, -- Need M

| | |
|---|---|
| configuredGrantConfigToAddModList-r17 | ConfiguredGrantConfigToAddModList-r16 |

OPTIONAL, -- Need N

| | |
|---|---|
| configuredGrantConfigToReleaseList-r17 | ConfiguredGrantConfigToReleaseList-r16 |

OPTIONAL, -- Need N
...
}
...

SDT-MAC-PHY-CG-Config field descriptions

cg-SDT-ConfigInitialBWP-DL
Downlink BWP configuration for CG-SDT. If a UE is a RedCap UE and if the initialDownlinkBWP-RedCap is configured in
downlinkConfigCommon in SIB1, this field is configured for initialDownlinkBWP-RedCap, otherwise it is configured for
initialDownlinkBWP.
cg-SDT-CS-RNTI
The CS-RNTI value for CG-SDT as specified in TS 38.321 [3].

### **************************************Next Quotation**************************************

### BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

BWP-UplinkCommon information element

| | |
|---|---|
| BWP-UplinkCommon ::= | SEQUENCE { |
| genericParameters | BWP, |
| rach-ConfigCommon | SetupRelease { RACH-ConfigCommon } |

OPTIONAL, -- Need M

| | |
|---|---|
| pusch-ConfigCommon | SetupRelease { PUSCH-ConfigCommon } |

OPTIONAL, -- Need M
...

| | |
|---|---|
| msgA-ConfigCommon-r16 | SetupRelease { MsgA-ConfigCommon-r16 } |

OPTIONAL -- Cond SpCellOnly2
...

| | |
|---|---|
| additionalRACH-ConfigList-r17 | SetupRelease { AdditionalRACH-ConfigList-r17 } |

OPTIONAL, -- Cond SpCellOnly2

| | |
|---|---|
| rsrp-ThresholdMsg3-r17 | RSRP-Range |

OPTIONAL, -- Need R

| | |
|---|---|
| numberOfMsg3-RepetitionsList-r17 | SEQUENCE (SIZE (4)) OF NumberOfMsg3-Repetitions-r17 |

OPTIONAL, -- Cond Msg3Rep
...
}

| | |
|---|---|
| AdditionalRACH-ConfigList-r17 ::= | SEQUENCE (SIZE(1..maxAdditionalRACH-r17)) OF AdditionalRACH- |

Config-r17

| | |
|---|---|
| AdditionalRACH-Config-r17 ::= | SEQUENCE { |
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Need R
...
}

| | |
|---|---|
| NumberOfMsg3-Repetitions-r17::= | ENUMERATED {n1, n2, n3, n4, n7, n8, n12, n16} |

BWP-UplinkCommon field descriptions

additionalRACH-ConfigList
List of feature or feature combination-specific RACH configurations, i.e. the RACH configurations configured in addition
to the one configured by rach-ConfigCommon and by msgA-ConfigCommon. The network associates all possible
preambles of an additional RACH configuration to one or more feature(s) or feature combination(s). The network does
not configure this list to have more than 16 entries. If both rach-ConfigCommon and msgA-ConfigCommon are
configured for a specific FeatureCombination, the network always provides them in the same additionalRACH-Config.
msgA-ConfigCommon
Configuration of the cell specific PRACH and PUSCH resource parameters for transmission of MsgA in 2-step random
access type procedure. The NW can configure msgA-ConfigCommon only for UL BWPs if the linked DL BWPs (same
bwp-Id as UL-BWP) are the initial DL BWPs or DL BWPs containing the SSB associated to the initial DL BWP or for
RedCap UEs DL BWPs associated with nonCellDefiningSSB or the RedCap-specific initial downlink BWP.
numberOfMsg3-RepetitionsList
The number of repetitions for PUSCH transmission scheduled by RAR UL grant and DCI format 0_0 with CRC scrambled
by TC-RNTI. This field is only applicable when the UE selects Random Access resources indicating Msg3 repetition in
this BWP. If this field is absent when the set(s) of Random Access resources with MSG3 repetition indication are
configured in the BWP-UplinkCommon, the UE shall apply the values {n1, n2, n3, n4} (see TS 38.214, clause 6.1.2.1).
rach-ConfigCommon
Configuration of cell specific random access parameters which the UE uses for contention based and contention free
random access as well as for contention based beam failure recovery in this BWP. The NW configures SSB-based RA
(and hence RACH-ConfigCommon) only for UL BWPs if the linked DL BWPs (same bwp-Id as UL-BWP) are the initial DL
BWPs or DL BWPs containing the SSB associated to the initial DL BWP or for RedCap UEs DL BWPs associated with
nonCellDefiningSSB or the RedCap-specific initial downlink BWP. The network configures rach-ConfigCommon,
whenever it configures contention free random access (for reconfiguration with sync or for beam failure recovery). For
RedCap-specific initial uplink BWP, rach-ConfigCommon is always configured when msgA-ConfigCommon is configured
in this BWP.
rsrp-ThresholdMsg3
Threshold used by the UE for determining whether to select resources indicating Msg3 repetition in this BWP, as
specified in TS 38.321 [3]. The field is mandatory if both set(s) of Random Access resources with MSG3 repetition
indication and set(s) of Random Access resources without MSG3 repetition indication are configured in the BWP. It is
absent otherwise.

### BWP-UplinkDedicated

The IE BWP-UplinkDedicated is used to configure the dedicated (UE specific) parameters of an uplink BWP.

### BWP-UplinkDedicated Information Element

| | |
|---|---|
| BWP-UplinkDedicated ::= | SEQUENCE { |

...

| | |
|---|---|
| configuredGrantConfig | SetupRelease { ConfiguredGrantConfig } |

OPTIONAL, -- Need M
...

| | |
|---|---|
| configuredGrantConfigToAddModList-r16 | ConfiguredGrantConfigToAddModList-r16 |

OPTIONAL, -- Need N
...
}

| | |
|---|---|
| ConfiguredGrantConfigToAddModList-r16 | ::= SEQUENCE (SIZE (1..maxNrofConfiguredGrantConfig-r16)) OF |

ConfiguredGrantConfig
...

BWP-UplinkDedicated field descriptions

configuredGrantConfig
A Configured-Grant of type1 or type2. It may be configured for UL or SUL but in case of type1 not for both at a time.
Except for reconfiguration with sync, the NW does not reconfigure configuredGrantConfig when there is an active
configured uplink grant Type 2 (see TS 38.321 [3]). However, the NW may release the configuredGrantConfig at any
time. Network can only configure configured grant in one BWP using either this field or
configuredGrantConfigToAddModList.
configuredGrantConfigToAddModList
Indicates a list of one or more configured grant configurations to be added or modified for one BWP. Except for
reconfiguration with sync, the NW does not reconfigure a Type 2 configured grant configuration when it is active (see TS
38.321 [3]). The network configures multiple CG configurations for one BWP with either all configurations or no
configuration configured with cg-RetransmissionTimer-r16.

### ConfiguredGrantConfig

The IE ConfiguredGrantConfig is used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one BWP of a serving cell.

. . .

### MsgA-ConfigCommon

The IE MsgA-ConfigCommon is used to configure the PRACH and PUSCH resource for transmission of MsgA in 2-step random access type procedure.

| | |
|---|---|
| MsgA-ConfigCommon-r16 ::= | SEQUENCE { |
| rach-ConfigCommonTwoStepRA-r16 | RACH-ConfigCommonTwoStepRA-r16, |
| msgA-PUSCH-Config-r16 | MsgA-PUSCH-Config-r16 |

OPTIONAL --Cond InitialBWPConfig
}
...

### MsgA-PUSCH-Config

The IE MsgA-PUSCH-Config is used to specify the PUSCH allocation for MsgA in 2-step random access type procedure.

MsgA-PUSCH-Config information element

| | |
|---|---|
| MsgA-PUSCH-Config-r16 ::= | SEQUENCE { |
| msgA-PUSCH-ResourceGroupA-r16 | MsgA-PUSCH-Resource-r16 ::= |

OPTIONAL, -- Cond InitialBWPConfig

| | |
|---|---|
| msgA-PUSCH-ResourceGroupB-r16 | MsgA-PUSCH-Resource-r16 ::= |

OPTIONAL, -- Cond GroupBConfigured

| | |
|---|---|
| msgA-TransformPrecoder-r16 | ENUMERATED {enabled, disabled} |

OPTIONAL, -- Need R

| | |
|---|---|
| msgA-DataScramblingIndex-r16 | INTEGER (0..1023) |

OPTIONAL, -- Need S
...
}

| | |
|---|---|
| MsgA-PUSCH-Resource-r16 ::= | SEQUENCE { |
| msgA-MCS-r16 | INTEGER (0..15), |
| nrofSlotsMsgA-PUSCH-r16 | INTEGER (1..4), |
| nrofMsgA-PO-PerSlot-r16 | ENUMERATED {one, two, three, six}, |
| msgA-PUSCH-TimeDomainOffset-r16 | INTEGER (1..32), |
| msgA-PUSCH-TimeDomainAllocation-r16 | INTEGER (1..maxNrofUL-Allocations) |

OPTIONAL, -- Need S

| | |
|---|---|
| startSymbolAndLengthMsgA-PO-r16 | INTEGER (0..127) |

OPTIONAL, -- Need S

| | |
|---|---|
| mappingTypeMsgA-PUSCH-r16 | ENUMERATED {typeA, typeB} |

OPTIONAL, -- Need S

| | |
|---|---|
| guardPeriodMsgA-PUSCH-r16 | INTEGER (0..3) |

OPTIONAL, -- Need R

| | |
|---|---|
| guardBandMsgA-PUSCH-r16 | INTEGER (0..1), |
| frequencyStartMsgA-PUSCH-r16 | INTEGER (0..maxNrofPhysicalResourceBlocks−1), |
| nrofPRBs-PerMsgA-PO-r16 | INTEGER (1..32), |
| nrofMsgA-PO-FDM-r16 | ENUMERATED {one, two, four, eight}, |
| msgA-IntraSlotFrequencyHopping-r16 | ENUMERATED {enabled} |

OPTIONAL, -- Need R

| | |
|---|---|
| msgA-HoppingBits-r16 | BIT STRING (SIZE(2)) |

OPTIONAL, -- Cond FreqHopConfigured
...
}
...

### RACH-ConfigCommon

The IE RACH-ConfigCommon is used to specify the cell specific random-access parameters.

### RACH-ConfigCommon Information Element

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-Msg3SizeGroupA | ENUMERATED {b56, b144, b208, b256, b282, b480, b640, |
| | b800, b1000, b72, spare6, spare5,spare4, |

spare3, spare2, spare1},

| | |
|---|---|
| messagePowerOffsetGroupB | ENUMERATED { minusinfinity, dB0, dB5, dB8, dB10, dB12, |

dB15, dB18},

| | |
|---|---|
| numberOfRA-PreamblesGroupA | INTEGER (1..64) |

}
OPTIONAL, -- Need R

| | |
|---|---|
| ra-ContentionResolutionTimer | ENUMERATED { sf8, sf16, sf24, sf32, sf40, sf48, sf56, |

sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |
| 1839 | INTEGER (0..837), |
| 1139 | INTEGER (0..137) |

},

| | |
|---|---|
| msg1-SubcarrierSpacing | SubcarrierSpacing |

```
OPTIONAL, -- Cond L139
  ...
  [[
```

| | |
|---|---|
| ra-PrioritizationForAccessIdentity-r16 | SEQUENCE { |
| ra-Prioritization-r16 | RA-Prioritization, |
| ra-PrioritizationForAI-r16 | BIT STRING (SIZE (2)) |

}
OPTIONAL, -- Cond InitialBWP-Only

| | |
|---|---|
| prach-Root Sequence Index-r16 | CHOICE { |
| 1571 | INTEGER (0..569), |
| 11151 | INTEGER (0..1149) |

```
  } OPTIONAL -- Need R
  ]],
```

| | |
|---|---|
| ra-PrioritizationForSlicing-r17 | RA-PrioritizationForSlicing-r17 |

OPTIONAL, -- Cond InitialBWP-Only

| | |
|---|---|
| featureCombinationPreamblesList-r17 | SEQUENCE (SIZE(1..maxFeatureCombPreamblesPerRACHResource- |

r17)) OF FeatureCombinationPreambles-r17 OPTIONAL -- Cond AdditionalRACH
}
...

### RACH-ConfigCommonTwoStepRA

The IE RACH-ConfigCommonTwoStepRA is used to specify cell specific 2-step random-access type parameters.

### RACH-ConfigCommonTwoStepRA Information Element

| | |
|---|---|
| RACH-ConfigCommonTwoStepRA-r16 ::= | SEQUENCE { |
| rach-ConfigGenericTwoStepRA-r16 | RACH-ConfigGenericTwoStepRA-r16, |
| msgA-TotalNumberOfRA-Preambles-r16 | INTEGER (1..63) |

OPTIONAL, -- Need S
msgA-SSB-PerRACH-OccasionAndCB-PreamblesPerSSB-r16 CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

}
OPTIONAL, -- Cond 2StepOnly

| | |
|---|---|
| msgA-CB-PreamblesPerSSB-PerSharedRO-r16 | INTEGER (1..60) |

OPTIONAL, -- Cond SharedRO

| | |
|---|---|
| msgA-SSB-SharedRO-MaskIndex-r16 | INTEGER (1..15) |

OPTIONAL, -- Need S

| | |
|---|---|
| groupB-ConfiguredTwoStepRA-r16 | GroupB-ConfiguredTwoStepRA-r16 |

OPTIONAL, -- Need S

| | |
|---|---|
| msgA-PRACH-Root Sequence Index-r16 | CHOICE { |
| 1839 | INTEGER (0..837), |
| 1139 | INTEGER (0..137), |
| 1571 | INTEGER (0..569), |
| 11151 | INTEGER (0..1149) |

}
OPTIONAL, -- Cond 2StepOnly

| | |
|---|---|
| msgA-TransMax-r16 | ENUMERATED {n1, n2, n4, n6, n8, n10, n20, |

n50, n100, n200} OPTIONAL, -- Need R

| | |
|---|---|
| msgA-RSRP-Threshold-r16 | RSRP-Range |

OPTIONAL, -- Cond 2Step4Step

| | |
|---|---|
| msgA-RSRP-ThresholdSSB-r16 | RSRP-Range |

OPTIONAL, -- Need R

| | |
|---|---|
| msgA-SubcarrierSpacing-r16 | SubcarrierSpacing |

OPTIONAL, -- Cond 2StepOnlyL139
...

| | |
|---|---|
| ra-PrioritizationForAccessIdentityTwoStep-r16 | SEQUENCE { |
| ra-Prioritization-r16 | RA-Prioritization, |
| ra-PrioritizationForAI-r16 | BIT STRING (SIZE (2)) |

}
OPTIONAL, -- Cond InitialBWP-Only

| | |
|---|---|
| ra-ContentionResolutionTimer-r16 | ENUMERATED {sf8, sf16, sf24, sf32, sf40, |

sf48, sf56, sf64} OPTIONAL, -- Cond 2StepOnly
...,

| | |
|---|---|
| ra-PrioritizationForSlicingTwoStep-r17 | RA-PrioritizationForSlicing-r17 |

OPTIONAL, -- Cond InitialBWP-Only
featureCombinationPreamblesList-r17 SEQUENCE (SIZE(1..maxFeatureCombPreamblesPerRACHResource-
r17)) OF FeatureCombinationPreambles-r17 OPTIONAL -- Cond AdditionalRACH
}

| | |
|---|---|
| GroupB-ConfiguredTwoStepRA-r16 ::= | SEQUENCE { |
| ra-MsgA-SizeGroupA | ENUMERATED {b56, b144, b208, b256, b282, |

b480, b640, b800,

b1000, b72, spare6, spare5,

spare4, spare3, spare2, spare1},

| | |
|---|---|
| messagePowerOffsetGroupB | ENUMERATED {minusinfinity, dB0, dB5, dB8, |

dB10, dB12, dB15, dB18},

| | |
|---|---|
| numberOfRA-PreamblesGroupA | INTEGER (1..64) |

}
...

### RACH-ConfigDedicated

The IE RACH-ConfigDedicated is used to specify the dedicated random access parameters.

### RACH-ConfigDedicated Information Element

| | |
|---|---|
| RACH-ConfigDedicated ::= | SEQUENCE { |
| cfra | CFRA |

OPTIONAL, -- Need S

| | |
|---|---|
| ra-Prioritization | RA-Prioritization |

OPTIONAL, -- Need N
...,

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL, -- Need S
}

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, two, four, |

eight, sixteen}
OPTIONAL -- Cond Mandatory
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA-CSIRS- |

Resource,

| | |
|---|---|
| rsrp-ThresholdCSI-RS | RSRP-Range |

```
    }
  },
  ...,
  totalNumberOfRA-Preambles INTEGER (1..63)
OPTIONAL -- Cond Occasions
}
```

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, one, |
| | two, four, eight, sixteen} |

}
OPTIONAL, -- Need S

| | |
|---|---|
| msgA-CFRA-PUSCH-r16 | MsgA-PUSCH-Resource-r16, |
| msgA-TransMax-r16 | ENUMERATED {n1, n2, n4, n6, n8, n10, n20, n50, n100, |

n200} OPTIONAL, -- Need S

| | |
|---|---|
| resourcesTwoStep-r16 | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

```
  },
  ...
}
```

| | |
|---|---|
| CFRA-SSB-Resource ::= | SEQUENCE { |
| ssb | SSB-Index, |
| ra-PreambleIndex | INTEGER (0..63), |
| msgA-PUSCH-Resource-Index-r16 | INTEGER (0..3071) OPTIONAL -- Cond 2StepCFRA |

}

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER (0..maxRA- |

Occasions−1),

| | |
|---|---|
| ra-PreambleIndex | INTEGER (0..63), |

...
}
...

### RACH-ConfigGeneric

The IE RACH-ConfigGeneric is used to specify the random-access parameters both for regular random access as well as for beam failure recovery.

### RACH-ConfigGeneric Information Element

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks−1), |

...

| | |
|---|---|
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

...

| | |
|---|---|
| ra-ResponseWindow-v1700 | ENUMERATED {sl240, sl320, sl640, sl960, sl1280, |

sl1920, sl2560} OPTIONAL -- Need R
}
...

### RACH-ConfigGenericTwoStepRA

The IE RACH-ConfigGenericTwoStepRA is used to specify the 2-step random access type parameters.

### RACH-ConfigGenericTwoStepRA Information Element

| | |
|---|---|
| RACH-ConfigGenericTwoStepRA-r16 ::= | SEQUENCE { |
| msgA-PRACH-ConfigurationIndex-r16 | INTEGER (0..262) |

OPTIONAL, -- Cond 2StepOnly

| | |
|---|---|
| msgA-RO-FDM-r16 | ENUMERATED {one, two, four, eight} |

OPTIONAL, -- Cond 2StepOnly

| | |
|---|---|
| msgA-RO-FrequencyStart-r16 | INTEGER (0..maxNrofPhysicalResourceBlocks−1) |

OPTIONAL, -- Cond 2StepOnly
...

| | |
|---|---|
| msgB-ResponseWindow-r16 | ENUMERATED {sl1, sl2, sl4, sl8, sl10, sl20, sl40, sl80, |

sl160, sl320}
OPTIONAL, -- Cond NoCFRA

| | |
|---|---|
| preambleTransMax-r16 | ENUMERATED {n3, n4, n5, n6, n7, n8, n10, n20, n50, n100, |

n200} OPTIONAL, -- Cond 2StepOnlyNoCFRA
...,

| | |
|---|---|
| msgB-ResponseWindow-v1700 | ENUMERATED {sl240, sl640, sl960, sl1280, sl1920, sl2560} |

OPTIONAL -- Cond NoCFRA2
}
************************************** Quotation End **************************************

In TS 38.213 ([6] 3GPP TS 38.213 V17.7.0 (2023-09) 3GPP), synchronization procedures, RA procedure, uplink power control and sidelink power control are specified:

### **************************************QUOTATION [6] START**************************************

### 4 Synchronization Procedures

### 4.1 Cell Search

Cell search is the procedure for a UE to acquire time and frequency synchronization with a cell and to detect the physical layer Cell ID of the cell.

A UE receives the following synchronization signals (SS) in order to perform cell search: the primary synchronization signal (PSS) and secondary synchronization signal (SSS) as defined in [TS 38.211].

A UE assumes that reception occasions of a physical broadcast channel (PBCH), PSS, and SSS are in consecutive symbols, as defined in [TS 38.211], and form a SS/PBCH block. The UE assumes that SSS, PBCH DM-RS, and PBCH data have same EPRE . . . .

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A.

Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the UL/SUL indicator field value from the detected PDCCH order to determine the UL carrier for the corresponding PRACH transmission.

### 8.1 Random Access Preamble

Physical random access procedure is triggered upon request of a PRACH transmission by higher layers or by a PDCCH order. A configuration by higher layers for a PRACH transmission includes the following:
A configuration for PRACH transmission [TS 38.211].
A preamble index, a preamble SCS, P_{PRACH,target}, a corresponding RA-RNTI, and a PRACH resource.

A PRACH is transmitted using the selected PRACH format with transmission power P_{PRACH,b,f,c}(i), as described in clause 7.4, on the indicated PRACH resource.

For Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For Type-2 random access procedure with common configuration of PRACH occasions with Type-1 random access procedure, a UE is provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB-PerSharedRO. The PRACH transmission can be on a subset of PRACH occasions associated with a same SS/PBCH block index within an SSB-RO mapping cycle for a UE provided with a PRACH mask index by msgA-SSB-SharedRO-MaskIndex according to [3, TS 38.321].

For Type-2 random access procedure with separate configuration of PRACH occasions with Type-1 random access procedure, a UE is provided a number N of SS/PBCH block indexes associated with one PRACH occasion and a number R of contention based preambles per SS/PBCH block index per valid PRACH occasion by msgA-SSB-PerRACH-OccasionAndCB-PreamblesPerSSB when provided; otherwise, by ssb-perRACH-OccasionAndCB-PreamblesPerSSB.

For a random access procedure associated with a feature combination indicated by Feature Combination Preambles, a UE is provided a number N of SS/PBCH block indexes associated with one PRACH occasion by ssb-perRACH-OccasionAndCB-PreamblesPerSSB or msgA-SSB-PerRACH-OccasionAndCB-PreamblesPerSSB when provided and a number S of contention based preambles per SS/PBCH block index per valid PRACH occasion by startPreambleForThisPartition and numberOfPreamblesPerSSB-ForThisPartition. The PRACH transmission can be on a subset of PRACH occasions associated with a same SS/PBCH block index within an SSB-RO mapping cycle for a UE provided with a PRACH mask index by ssb-SharedRO-MaskIndex according to [3, TS 38.321].

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·N_{preamble}^{total}/N where N_{preamble}^{total} is provided by totalNumberOfRA-Preambles for Type-1 random access procedure, or by msgA-TotalNumberOfRA-Preambles for Type-2 random access procedure with separate configuration of PRACH occasions from a Type 1 random access procedure, and is an integer multiple of N.

For Type-2 random access procedure with common configuration of PRACH occasions with Type-1 random access procedure, if N<1, one SS/PBCH block index is mapped to 1/N consecutive valid PRACH occasions and Q contention based preambles with consecutive indexes associated with the SS/PBCH block index per valid PRACH occasion start from preamble index R. If N≥1, Q contention based preambles with consecutive indexes associated with SS/PBCH block index n, 0≤n≤N−1, per valid PRACH occasion start from preamble index n·N_{preamble}^{total}/N+R, where N_{preamble}^{total} is provided by totalNumberOfRA-Preambles for Type-1 random access procedure.

. . .

SS/PBCH block indexes provided by ssb-PositionsInBurst in SIB1 or in ServingCellConfigCommon are mapped to valid PRACH occasions in the following order where the parameters are described in [TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

An association period, starting from frame 0, for mapping SS/PBCH block indexes to PRACH occasions is the smallest value in the set determined by the PRACH configuration period according Table 8.1-1 such that N_{SSB}^{Tx} SS/PBCH block indexes are mapped at least once to the PRACH occasions within the association period, where a UE obtains N_{SSB}^{Tx} from the value of ssb-PositionsinBurst in SIB1 or in ServingCellConfigCommon . . . .

For a PRACH transmission by a UE triggered by a PDCCH order, the PRACH mask index field [TS 38.212], if the value of the random access preamble index field is not zero, indicates the PRACH occasion for the PRACH transmission where the PRACH occasions are associated with the SS/PBCH block index indicated by the SS/PBCH block index field of the PDCCH order. If the UE is provided K_{cell,offset} by cellSpecificKoffset, the PRACH occasion is after slot n+2^{μ}. K_{cell,offset} where n is the slot of the UL BWP for the PRACH transmission that overlaps with the end of the PDCCH order reception assuming T_{TA}=0, and μ is the SCS configuration for the PRACH transmission . . . .

For a PRACH transmission triggered by higher layers, if ssb-ResourceList is provided, the PRACH mask index is indicated by ra-ssb-OccasionMaskIndex which indicates the PRACH occasions for the PRACH transmission where the PRACH occasions are associated with the selected SS/PBCH block index.

The PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For the indicated preamble index, the ordering of the PRACH occasions is
First, in increasing order of frequency resource indexes for frequency multiplexed PRACH occasions
Second, in increasing order of time resource indexes for time multiplexed PRACH occasions within a PRACH slot
Third, in increasing order of indexes for PRACH slots

For a PRACH transmission triggered upon request by higher layers, a value of ra-OccasionList [5, TS 38.331], if csirs-ResourceList is provided, indicates a list of PRACH occasions for the PRACH transmission where the PRACH occasions are associated with the selected CSI-RS index indicated by csi-RS. The indexing of the PRACH occasions indicated by ra-OccasionList is reset per association pattern period.

TABLE 8.1-1
Mapping between PRACH configuration period and SS/PBCH
block to PRACH occasion association period

| | Association period |
|---|---|
| PRACH configuration | (number of PRACH |
| period (msec) | configuration periods) |
| 10 | {1, 2, 4, 8, 16} |
| 20 | {1, 2, 4, 8} |
| 40 | {1, 2, 4} |
| 80 | {1, 2} |
| 160 | {1} |

If a random access procedure is initiated by a PDCCH order, the UE, if requested by higher layers, transmits a PRACH in the selected PRACH occasion, as described in [3, TS 38.321], for which a time between the last symbol of the PDCCH order reception and the first symbol of the PRACH transmission is larger than or equal to N_{T,2}+Δ_{BWPSwitching}+Δ_{Delay}+T_{switch} msec, where
N_{T,2} is a time duration of N₂ symbols corresponding to a PUSCH preparation time for UE processing capability 1 [TS 38.214] assuming μ corresponds to the smallest SCS configuration between the SCS configuration of the PDCCH order and the SCS configuration of the corresponding PRACH transmission
Δ_{BWPSwitching}=0 if the active UL BWP does not change and Δ_{BWPSwitching} is defined in [TS 38.133] otherwise
Δ_{Delay}=0.5 msec for FR1 and Δ_{Delay}=0.25 msec for FR2
T_{switch} is a switching gap duration as defined in [TS 38.214]
   . . .

### 8.1A PUSCH for Type-2 Random Access Procedure

For a Type-2 random access procedure, a UE transmits a PUSCH, when applicable, after transmitting a PRACH. The UE encodes a transport block provided for the PUSCH transmission using redundancy version number 0. The PUSCH transmission is after the PRACH transmission by at least N symbols where N=2 for μ=0 or μ=1, N=4 for μ=2 or μ=3, N=16 for μ=5, N=32 for μ=6, and μ is the SCS configuration for the active UL BWP.

A UE does not transmit a PUSCH in a PUSCH occasion if the PUSCH occasion associated with a DMRS resource is not mapped to a preamble of valid PRACH occasions or if the associated PRACH preamble is not transmitted as described in clause 7.5 or clause 11.1 or clause 15 or clause 17.2. A UE can transmit a PRACH preamble in a valid PRACH occasion if the PRACH preamble is not mapped to a valid PUSCH occasion.

A mapping between one or multiple PRACH preambles and a PUSCH occasion associated with a DMRS resource is per PUSCH configuration provided by MsgA-PUSCH-Resource.

A UE determines time resources and frequency resources for PUSCH occasions in an active UL BWP from msgA-PUSCH-Config or separateMsgA-PUSCH-Config for the active UL BWP. If the active UL BWP is not the initial UL BWP and msgA-PUSCH-Config or separateMsgA-PUSCH-Config is not provided for the active UL BWP, the UE uses the msgA-PUSCH-Config or separateMsgA-PUSCH-Config provided for the initial UL BWP.

A UE determines a first interlace or first RB for a first PUSCH occasion in an active UL BWP respectively from interlaceIndexFirstPO-MsgA-PUSCH or from frequencyStartMsgA-PUSCH that provides an offset, in number of RBs in the active UL BWP, from a first RB of the active UL BWP. A PUSCH occasion includes a number of interlaces or a number of RBs provided by nrofInterlacesPerMsgA-PO or by nrofPRBs-perMsgA-PO, respectively. Consecutive PUSCH occasions in the frequency domain of an UL BWP are separated by a number of RBs provided by guardBandMsgA-PUSCH. A number N_{f} of PUSCH occasions in the frequency domain of an UL BWP is provided by nrofMsgA-PO-FDM.

. . .

If a UE does not have dedicated RRC configuration, or has an initial UL BWP as an active UL BWP, or is not provided startSymbolAndLengthMsgA-PO, msgA-PUSCH-timeDomainAllocation provides a SLIV and a PUSCH mapping type for a PUSCH transmission by indicating
one of the first maxNrofUL-Allocations values from PUSCH-TimeDomainResourceAllocationList, if PUSCH-Time Domain ResourceAllocation List is provided in PUSCH-ConfigCommon
one of the entries from table 6.1.2.1.1-2 or table 6.1.2.1.1-3 in [TS 38.214], if PUSCH-Time Domain ResourceAllocationList is not provided in PUSCH-ConfigCommon
   else, the UE is provided a SLIV by startSymbolAndLengthMsgA-PO, and a PUSCH mapping type by mapping TypeMsgA-PUSCH for a PUSCH transmission.

For mapping one or multiple preambles of a PRACH slot to a PUSCH occasion associated with a DMRS resource, a UE determines a first slot for a first PUSCH occasion in an active UL BWP from msgA-PUSCH-TimeDomainOffset that provides an offset, in number of slots in the active UL BWP, relative to the start of a PUSCH slot including the start of each PRACH slot. The UE does not expect to have a PRACH preamble transmission and a PUSCH transmission with a msgA in a PRACH slot or in a PUSCH slot, or to have overlapping msgA PUSCH occasions for a MsgA PUSCH configuration. The UE expects that a first PUSCH occasion in each slot has a same SLIV for a PUSCH transmission that is provided by startSymbolAndLengthMsgA-PO or msgA-PUSCH-timeDomainAllocation [TS 38.214].

Consecutive PUSCH occasions within each slot are separated by guardPeriodMsgA-PUSCH symbols and have same duration. A number N, of time domain PUSCH occasions in each slot is provided by nrofMsgA-PO-perSlot and a number Ns of consecutive slots that include PUSCH occasions is provided by nrofSlotsMsgA-PUSCH.

A PUSCH occasion for PUSCH transmission is defined by a frequency resource and a time resource, and is associated with a DMRS resource. The DMRS resources are provided by msgA-DMRS-Config.

Each consecutive number of N_{preamble} preamble indexes from valid PRACH occasions in a PRACH slot
first, in increasing order of preamble indexes within a single PRACH occasion
second, in increasing order of frequency resource indexes for frequency multiplexed PRACH occasions
third, in increasing order of time resource indexes for time multiplexed PRACH occasions within a PRACH slot are mapped to a valid PUSCH occasion and the associated DMRS resource
first, in increasing order of frequency resource indexes f_{id} for frequency multiplexed PUSCH occasions
second, in increasing order of DMRS resource indexes within a PUSCH occasion, where a DMRS resource index DMRS_{id} is determined first in an ascending order of a DMRS port index and second in an ascending order of a DMRS sequence index
third, in increasing order of time resource indexes t_{id} for time multiplexed PUSCH occasions within a PUSCH slot
fourth, in increasing order of indexes for Ns PUSCH slots
   where N_{preamble}=cell(T_{preamble}/T_{PUSCH}), T_{preamble} is a total number of valid PRACH occasions per association pattern period multiplied by the number of preambles per valid PRACH occasion provided by rach-ConfigCommonTwoStepRA, and T_{PUSCH} is a total number of valid PUSCH occasions per PUSCH configuration per association pattern period multiplied by the number of DMRS resource indexes per valid PUSCH occasion provided by msgA-DMRS-Config.

A PUSCH occasion is valid if it does not overlap in time and frequency with any valid PRACH occasion associated with either a Type-1 random access procedure or a Type-2 random access procedure. Additionally, for unpaired spectrum and for SS/PBCH blocks with indexes provided by ssb-PositionsInBurst in SIB1 or by ServingCellConfigCommon
if a UE is not provided tdd-UL-DL-ConfigurationCommon, a PUSCH occasion is valid if the PUSCH occasion
   does not precede a SS/PBCH block in the PUSCH slot, and
   starts at least N_{gap} symbols after a last SS/PBCH block symbol, where N_{gap} is provided in Table 8.1-2 and, if channelAccessMode=“semiStatic” is provided, does not overlap with a set of consecutive symbols before the start of a next channel occupancy time where the UE does not transmit.
   if a UE is provided tdd-UL-DL-ConfigurationCommon, a PUSCH occasion is valid if the PUSCH occasion
is within UL symbols, or
does not precede a SS/PBCH block in the PUSCH slot, and
starts at least N_{gap} symbols after a last downlink symbol and at least N_{gap} symbols after a last SS/PBCH block symbol, where N_{gap} is provided in Table 8.1-2 and, if channelAccessMode=“semiStatic” is provided, does not overlap with a set of consecutive symbols before the start of a next channel occupancy time where the UE does not transmit.

### **************************************QUOTATION [6] END**************************************

In recent years, more devices are expected to be interconnected in the wireless communication world for improving productivity efficiency and increasing comforts of life. However, powering all of the Internet of Things (IoT) devices by a battery that needs to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart home, etc.).

On the other hand, barcodes and Radio Frequency Identifications (RFIDs) have limited reading range of a few meters, which usually requires handheld scanning. This would lead to labor intensive and time-consuming operations. Also, the lack of an interference management scheme would result in severe interference between RFID readers and capacity problems, especially in case of dense deployment. It is hard to support a large-scale network with seamless coverage for RFIDs. In contrast, a study of ambient IoT investigates the feasibility of a new IoT technology within Third Generation Partnership Project (3GPP) systems.

An ambient IoT device/User Equipment (UE) would have ultra-low complexity, a very small device size, and a long life cycle. The ambient IoT device/UE would have complexity and power consumption orders of magnitude lower than the existing 3GPP Low Power Wide Area (LPWA) technologies (e.g., Narrowband (NB)-IoT, Enhanced Machine Type Communication (eMTC). The ambient IoT device/UE may not have energy storage or may have energy storage. The energy of the ambient IoT device/UE may be provided through the harvesting of radio waves, light, motion, heat, or any other power source that could be suitable. The energy and/or power source may be provided one-shot (e.g., unexpected or aperiodically), periodically, or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The Uplink (UL) transmission of the ambient IoT device/UE may be generated internally by the device/UE, or be backscattered on the carrier wave provided externally. More details regarding ambient IoT (device/UE) can be found in the study item [1] RP-234058 and [2] 3GPP TR 38.848 V18.0.0.

To enable data and/or signaling transmission or reception, a UE should be configured with at least some configuration(s) related to the data/signaling transmission or reception beforehand. For example, the configuration may include resource configuration for the data/signaling transmission or reception. For a normal/legacy UE in New Radio (NR), the UE may receive a common configuration via system information, and receive a UE-specific configuration via a dedicated signaling (e.g., Radio Resource Control (RRC) reconfiguration). However, for an ambient IoT UE, due to characteristics of ambient IoT such as ultra-low complexity and ultra-low power consumption, a lightweight signaling procedure should be pursued. It is assumed that Physical Broadcast Channels (PBCHs) and/or system information may not be applicable for ambient IoT devices. A method for an ambient IoT device/UE to acquire related configuration(s) and/or resource(s) for performing transmission (e.g., in response to a random access procedure for inventory triggered by network) should be designed.

A first UE may determine (or derive) at least a configuration (e.g., a first configuration) by a first method, wherein the configuration (e.g., the first configuration) is determined (or derived) by a second UE by a second method. The configuration may be used for a (data or signaling) transmission or reception. The configuration may be used for a Random Access (RA) procedure and/or initial access.

A network node may configure the first UE with the (first) configuration by the first method. The network node may provide the (first) configuration to the first UE by the first method. The network node may not configure the first UE with the (first) configuration by the second method. The network node may not provide the (first) configuration to the first UE by the second method.

The network node may configure the second UE with the (first) configuration by the second method. The network node may provide the (first) configuration to the second UE by the second method. The network node may not configure the second UE with the (first) configuration by the first method. The network node may not provide the (first) configuration to the second UE by the first method.

A first UE may perform a (data or signaling) transmission or reception without at least a configuration (e.g., a first configuration), wherein the configuration (e.g., the first configuration) is required (or used) by a second UE to perform a (data or signaling) transmission or reception.

The network node may not configure the first UE with the (first) configuration, e.g., for the first UE to perform a (data or signaling) transmission or reception. The network node may configure the second UE with the (first) configuration, e.g., for the second UE to perform a (data or signaling) transmission or reception.

The first UE may determine (or derive) the configuration (e.g., the first configuration) by the first method. The first UE may not determine (or derive) the configuration (e.g., the first configuration) by the second method. The first UE may determine (or apply, or use) a first value for the configuration.

The second UE may determine (or derive) the configuration (e.g., the first configuration) by the second method. The second UE may not determine (or derive) the configuration (e.g., the first configuration) by the first method. The second UE may determine (or apply, or use) a second value for the configuration.

The first method and the second method may be different. The first method and the second method may be the same. The method (e.g., the first method, the second method) may be (or include) one or more of the following.

Receive a Common Signaling (e.g., from Network)

The UE (e.g., the first UE, the second UE, a device) may receive a common signaling including at least the first configuration. The UE may apply the first configuration in response to receiving the common signaling including the first configuration. The UE may acquire the first configuration by the common signaling. The first configuration may be (or include) a cell-specific configuration. The first configuration may be (or include) a configuration common for multiple UEs, a group of UEs, and/or a UE group.

The common signaling may be (or include) a broadcast signaling. The common signaling may be received by more than one UE. The common signaling may be received by multiple UEs (or a group of UEs), e.g., in a UE group. The common signaling may be transmitted to more than one UE. The common signaling may be transmitted to multiple UEs (or a group of UEs), e.g., in a UE group. The common signaling may be (or include) system information, e.g., for ambient IoT. The common signaling may be (or include) paging, e.g., for ambient IoT. The common signaling may be (or include) any of RRC signaling (e.g., RRC configuration message), Medium Access Control (MAC) signaling (e.g., MAC Control Element (CE)), Layer 2 signaling, Physical Layer (PHY) signaling (e.g., Physical Downlink Control Channel (PDCCH), Downlink Control Information (DCI)), or Layer 1 signaling, e.g., for ambient IoT. The common signaling may be (or include) a carrier wave (signal) and/or an interrogation signal. The common signaling may be used to trigger (or indicate) a transmission (or reception), e.g., of the UE (e.g., the first UE, the second UE) and/or of multiple UEs. The transmission from the UE may be (or include) a backscattering transmission (or reception) or may be generated internally by the UE. The common signaling may be used to provide a power source and/or energy to the UE. The common signaling may be used to trigger (or indicate) an (random) access procedure (or initial access), e.g., of the UE and/or of multiple UEs.

Receive a Dedicated Signaling (e.g., from Network)

The UE (e.g., the first UE, the second UE, a device) may receive a dedicated signaling including at least the first configuration. The UE may apply the first configuration in response to receiving the dedicated signaling including the first configuration. The UE may acquire the first configuration by the dedicated signaling. The first configuration may be (or include) a UE-specific configuration. The first configuration may be (or include) a configuration dedicated for a (single) UE.

The dedicated signaling may be (or include) a UE-specific signaling. The dedicated signaling may be (or include) RRC signaling (e.g., an RRC configuration message). The dedicated signaling may be (or include) MAC signaling (e.g., a MAC CE). The dedicated signaling may be (or include) PHY signaling (e.g., PDCCH, DCI). The dedicated signaling may be (or include) a carrier wave (signal) and/or an interrogation signal. The dedicated signaling may be used to trigger (or indicate) a transmission (or reception) of the UE (e.g., the first UE, the second UE). The transmission from the UE may be (or include) a backscattering transmission (or reception) or may be generated internally by the UE. The dedicated signaling may be used to provide a power source and/or energy to the UE. The dedicated signaling may be used to trigger (or indicate) an RA procedure (or initial access) of the UE.

### Pre-Configured or Pre-Defined

The UE (e.g., the first UE, the second UE, a device) may apply (or use) a pre-configured (or pre-defined, or fixed) value for the first configuration. The UE may apply (or use) a pre-configured (or pre-defined, or fixed) configuration for the first configuration. The UE may not receive a signaling including at least the first configuration. The UE may apply (or use) the first configuration without receiving a signaling including at least the first configuration. The signaling may be a common signaling and/or a dedicated signaling. The UE may apply the pre-configured (or pre-defined, or fixed) value or configuration for performing backscattering transmission (or reception) or for performing the transmission generated internally by the UE. Preferably in certain embodiments, the UE may perform the transmission in response to reception/detection of a carrier wave (signal).

### Hybrid of the Above

The UE (e.g., the first UE, the second UE, a device) may determine the first configuration by a hybrid method. The UE may determine the first configuration by more than one method mentioned above.

In one or more examples, multiple values (or configurations) may be pre-configured (or pre-defined) for the first configuration, and a signaling (e.g., common, dedicated) may be used to indicate the UE which value (or configuration) among the multiple values (or configurations) is applied for the first configuration.

In one or more examples, the UE may receive a part of the first configuration by a first signaling (e.g., common signaling) and another part of the first configuration by a second signaling (e.g., dedicated signaling). The UE may apply the first configuration when/after/in response to receiving (both or one of) the first signaling and the second signaling.

In one or more examples, the UE may apply (or use) pre-configured (or pre-defined, or fixed) value(s) for the first configuration if the UE does not receive the signaling (e.g., common, dedicated). When the UE receives the signaling (e.g., common, dedicated), the UE may apply the first configuration indicated/provided by the signaling.

In one or more examples, when the UE detects/receives a first carrier wave (signal) and/or the UE does not yet receive the signaling (e.g., common, dedicated) during the first carrier wave (signal) duration, the UE may apply (or use) pre-configured (or pre-defined, or fixed) value(s) for performing a first transmission, which is with or associated with the first carrier wave (signal) duration. The first transmission may be a backscattering transmission (or reception), or a transmission generated internally by the UE. When the UE detects/receives a second carrier wave (signal) and/or the UE receives a first signaling (e.g., a common signaling, a dedicated signaling) during the second carrier wave (signal) duration, the UE may apply the first configuration indicated/provided by the first signaling for performing a second transmission, which is with or associated with the second carrier wave (signal) duration. The second transmission may be a backscattering transmission (or reception), or a transmission generated internally by the UE. When the UE detects/receives a third carrier wave (signal) and the UE receives a second signaling (e.g., a common signaling, a dedicated signaling) during the third carrier wave (signal) duration, the UE may apply the first configuration indicated/provided by the second signaling for performing a third transmission, which is with or associated with the third carrier wave (signal) duration. The third transmission may be a backscattering transmission (or reception), or a transmission generated internally by the UE.

The carrier wave (signal) duration may be a time duration when the UE could receive a carrier wave (signal). The carrier wave (signal) duration may start from when a (new) carrier wave (signal) is started. The carrier wave (signal) duration may end at when the carrier wave (signal) is stopped. The carrier wave (signal) duration may be detected by the UE or be defined/configured by the Network (NW).

To solve the issue, a first signaling (e.g., a common signaling) that triggers a transmission and/or a procedure (e.g., a random access procedure) could include or indicate a resource or configuration for (or to be used by) more than one UE/device (e.g., a group of UEs/devices). In response to receiving the first signaling, the UE/device may initiate the random access procedure and perform a first transmission based on the resource or configuration provided or indicated in the first signaling, wherein the first signaling is for more than one UE/device. The first signaling is transmitted or provided to the more than one UE/device.

In one or more examples, a first UE/device may receive a first signaling of triggering a transmission and/or a procedure (e.g., a (random) access procedure), e.g., from a network node or a second UE. The second UE may be an intermediated node, a reader, and/or a legacy UE. The first signaling may be a common signaling. The first signaling may be for more than one UE/device. The first signaling may be transmitted to the more than one UE/device. The first signaling may be received by the more than one UE/device. The first signaling may be used to trigger transmission(s) and/or procedure(s) (e.g., random access procedure(s)) for the more than one UE/device. The first signaling may (be used to) indicate the more than one UE/device to trigger the transmission(s) and/or procedure(s) (e.g., random access procedure(s)). The more than one UE/device may be a group of UEs/devices. The first signaling may be a paging (message) for ambient IoT. The first signaling may indicate (at least) the first UE/device, e.g., by comprising/indicating a device Identify (ID) of the first UE/device and/or a group ID of the first UE/device. The first signaling may indicate (at least) a third UE/device, e.g., by comprising/indicating a device ID of the third UE/device and/or a group ID of the third UE/device. The first signaling may not indicate the third UE/device. The more than one UE/device may comprise the first UE/device and/or the third UE/device. The more than one UE/device may be ambient IoT UE(s)/device(s). Preferably in certain embodiments, the first signaling does not mean/comprise system information or a physical broadcast channel.

In response to receiving the first signaling, the first UE/device may trigger the random access procedure and perform a first transmission of the random access procedure based on a first resource and/or a first configuration provided in the first signaling. The first UE/device may transmit the first transmission to the network node or the second UE. The first signaling may comprise and/or indicate (at least) the first resource and/or the first configuration (e.g., for the first UE/device). The first resource and/or the first configuration may be used for, associated with, and/or related to the random access procedure. The first resource and/or the first configuration may be used by, associated with, and/or related to the first UE/device. The first resource and/or the first configuration may be associated with the device ID of the first UE/device. The first resource and/or the first configuration may be associated with the group ID of the first UE/device. The first resource may comprise (at least) a first frequency (domain) resource/occasion(s) (set), and/or a first time (domain) resource/occasion(s) (set). The first resource may be determined based on the first configuration and/or a pre-configuration.

In response to receiving the first signaling, the third UE/device may trigger another random access procedure and/or perform another first transmission of the another random access procedure based on a second resource and/or a second configuration provided in the first signaling. The third UE/device may transmit the another first transmission to the network node or the second UE. The first signaling may comprise and/or indicate the second resource and/or the second configuration (e.g., for the third UE/device). The second resource and/or the second configuration may be used for, associated with, and/or related to the another random access procedure. The second resource and/or the second configuration may be used by, associated with, and/or related to the third UE/device. The second resource and/or the second configuration may be associated with the device ID of the third UE/device. The second resource and/or the second configuration may be associated with the group ID of the third UE/device. The second resource may comprise (at least) a second frequency (domain) resource/occasion(s) (set), and/or a second time (domain) resource/occasion(s) (set). The second resource may be determined based on the second configuration and/or another pre-configuration.

Throughout the present disclosure, when a UE determines a configuration, the UE may require, receive, derive, acquire, determine, store, apply, and/or use the configuration. The configuration (e.g., the first configuration) may be (or include) at least one or more of the following. The UE may determine different configurations by different methods. The configuration (e.g., the first configuration) may be (or include) one or more parameters of the following configuration(s).

### Configuration Related to Synchronization Signal Block (SSB) (or Channel State Information Reference Signal (CSI-RS))

The configuration may be (or include) any of: a Reference Signal Received Power (RSRP) threshold for SSB (e.g., rsrp-ThresholdSSB, msgA-RSRP-ThresholdSSB), an RSRP threshold for CSI-RS (e.g., rsrp-ThresholdCSI-RS), a beam failure recovery configuration, and/or ssb-PositionsInBurst.

The UE (e.g., ambient IoT UE, the first UE, the same below) may not require an SSB/CSI-RS related configuration, e.g., for a (data or signaling) transmission or reception, for an RA procedure. The UE may not be allowed to configure the SSB/CSI-RS related configuration. The UE may not perform SSB selection and/or CSI-RS selection, e.g., for a (data or signaling) transmission or reception, for an RA procedure. The UE may not select an SSB/CSI-RS, e.g., for a (data or signaling) transmission or reception, for an RA procedure. The UE may not be configured with parameter(s) associated with a beam. The UE may not be (explicitly) provided SSBs and/or CSI-RSs. RA resource(s)/configuration may be (only) allowed to be associated with a specific or same SSB. The UE may (always) select the specific or same SSB.

For another type of UE (e.g., non-ambient IoT UE, the second UE, the same below), the UE may receive the configuration by system information. The UE may require the configuration. The UE may perform SSB selection and/or CSI-RS selection, e.g., for a (data or signaling) transmission or reception, for an RA procedure. The UE may be configured with parameter(s) associated with a beam. The UE may be (explicitly) provided SSBs and/or CSI-RSs.

### Configuration Related to Bandwidth Part (BWP) (or Frequency Resource)

The configuration may be related to frequency resource(s). The configuration may be (or include) any of: initialUplinkBWP, initialDownlinkBWP, BWP, subcarrierSpacing, BWP-Downlink, BWP-DownInkCommon, BWP-DownlinkDedicated, BWP-Id, BWP-Uplink, BWP-UplinkCommon, BWP-UplinkDedicated.

The UE (e.g., ambient IoT UE, the first UE, the same below) may be configured with one or more (initial) BWPs of a cell. Alternatively and/or additionally, a cell may include or indicate more than one (initial) BWP (for ambient IoT). The UE may be configured with different initial BWPs in different bands and/or frequencies of a cell. The UE may be configured with multiple BWPs with spectrum deployment in-band to an NR cell. There may be different/separate RA configurations and/or RA resources configured on the more than one BWP. The RA configuration and/or RA resources may correspond to, be associated with, and/or be used by a (one or more) UE, UE group, UE type, power level, UL data type, and/or UL data size. The BWP may be UL BWP.

Preferably in certain embodiments, the BWP (in above or below) may be changed/represented/replaced by a frequency (sub-) band, frequency resource(s) set, or frequency resource(s). The BWP, bandwidth, and/or band may be for a Reader to (Ambient IoT) Device (R2D) and/or a (Ambient IoT) Device to Reader (D2R).

Preferably in certain embodiments, when the UE receives/detects a carrier wave (signal), an R2D signal/channel, and/or a Physical (Ambient IoT) Device to Reader Channel (PDRCH), the UE may derive/determine a (initial) BWP, a (initial) frequency (sub-) band or (initial) frequency resource set based on at least frequency (e.g., Downlink (DL) carrier or DL frequency band), e.g., frequency of a received/detected carrier wave (signal), an R2D signal/channel, and/or a Physical Reader (to Ambient IoT) Device Channel (PRDCH). Preferably in certain embodiments, the UE may derive/determine a (initial) BWP, a (initial) frequency (sub-) band or (initial) frequency resource set based on at least BWP, frequency (sub-) band, or frequency resource set information provided from network.

For another type of UE (e.g., non-ambient IoT UE, the second UE, the same below), the UE may receive the configuration by system information and/or a dedicated RRC signaling (e.g., RRC reconfiguration). The UE may be configured with one initial BWP.

Configuration Related to RA and/or D2R Transmission

The configuration may be (or include) any of: a 4-step RA configuration, a 2-step RA configuration, a contention-based RA configuration, a contention-free RA configuration, an RA resource configuration, an RA preamble configuration, an RA preamble group configuration, RACH-ConfigCommon, a PRACH configuration, RACH-ConfigCommonTwoStepRA, RACH-ConfigDedicated. RACH-ConfigGeneric, RACH-ConfigGenericTwoStepRA, and/or a PDRCH configuration.

The UE (e.g., ambient IoT UE/device, the first UE, the same below) may be configured with multiple RA configurations for a cell. Alternatively and/or additionally, a cell may provide or indicate multiple RA configurations (for ambient IoT). The UE may be configured with multiple RA resources groups. Alternatively and/or additionally, the cell may provide or indicate multiple RA resources groups (for ambient IoT). The UE may be configured with multiple RA configuration groups. Alternatively and/or additionally, the cell may provide or indicate multiple RA configuration groups (for ambient IoT). The multiple RA configurations, RA resources group, and/or RA configuration groups may be configured on different BWPs. The multiple RA configurations, RA resources group, and/or RA configuration groups may be configured on a same BWP. The RA configuration, RA resources group, and/or RA configuration group may correspond to, be associated with, and/or be used by the (one or more) UE, UE group, UE type, power level, UL data type, and/or UL data size.

For another type of UE (e.g., non-ambient IoT UE, the second UE, the same below), the UE may receive the configuration by system information and/or a dedicated RRC signaling (e.g., RRC reconfiguration).

### Configuration Related to Downlink Control Signaling

The configuration may be (or include) any of: a PDCCH configuration, a PRDCH configuration, a Control Resource Set (CORESET) configuration, a search space configuration, PDCCH-Config, PDCCH-ConfigCommon, PDCCH-ConfigSIB1, PDCCH-ServingCellConfig, ControlResourceSet, ControlResourceSetId, ControlResourceSetZero, SearchSpace, SearchSpaceId, and/or SearchSpaceZero.

The UE (e.g., ambient IoT UE, the first UE, the same below) may be configured with one (or more) PDCCH configuration, PRDCH configuration, CORESET configuration, and/or search space configuration. The UE may not be allowed to configure more than one PDCCH configuration, PRDCH configuration, CORESET configuration, and/or search space configuration. The UE may be pre-configured with one (or more) PDCCH configuration, PRDCH configuration, CORESET configuration, and/or search space configuration. The UE may use (or apply) a pre-configured (or fixed) value for the configuration. The UE may not require the configuration. The UE may not require the network to provide the configuration.

For another type of UE (e.g., non-ambient IoT UE, the second UE, the same below), the UE may receive the configuration by system information and/or a dedicated RRC signaling (e.g., RRC reconfiguration).

### Configuration Related to Paging

The configuration may be (or include) any of: a paging cycle configuration, a paging frame configuration, a paging occasion configuration, PCCH-config, and/or (default) PagingCycle.

The UE (e.g., ambient IoT UE/device, the first UE, the same below) may be configured with at least a configuration related to paging. The UE may be pre-configured with at least a configuration related to paging. The UE may use (or apply) a pre-configured (or fixed) value for the configuration. The UE may not require the configuration related to paging. The UE may not require the network to provide the configuration related to paging.

For another type of UE (e.g., non-ambient IoT UE, the second UE, the same below), the UE may receive the configuration by system information and/or a dedicated RRC signaling (e.g., RRC reconfiguration).

### Configuration Related to System Information

The configuration may be (or include) any of: a system information scheduling configuration, a system information modification configuration, a system information request configuration, BCCH-config, SI-SchedulingInfo, and/or SI-RequestConfig.

The UE (e.g., ambient IoT UE, the first UE, the same below) may be configured with at least a configuration related to system information. The UE may be pre-configured with at least a configuration related to system information. The UE may use (or apply) a pre-configured (or fixed) value for the configuration. The UE may not require the configuration related to system information. The UE may not require the network to provide the configuration related to system information.

For another type of UE (e.g., non-ambient IoT UE, the second UE, the same below), the UE may receive the configuration by system information.

### Configuration Related to Data Transmission or Reception

The configuration may be (or include) any of: PUSCH-Config, PUSCH-ConfigCommon, PUSCH-ServingCellConfig. PDSCH-Config. PDSCH-ConfigCommon, PDSCH-ServingCellConfig, a PRDCH configuration, a PDRCH configuration, a Semi-Persistent Scheduling (SPS) configuration, a configured grant configuration, and/or a Hybrid Automatic Repeat Request (HARQ) configuration.

The UE (e.g., ambient IoT UE/device, the first UE, the same below) may be configured with at least a configuration related to data transmission or reception. The UE may be pre-configured with at least the configuration. The UE may use (or apply) a pre-configured (or fixed) value for the configuration. The UE may not require the configuration. The UE may not require the network to provide the configuration.

For another type of UE (e.g., non-ambient IoT UE, the second UE, the same below), the UE may receive the configuration by system information and/or a dedicated RRC signaling (e.g., RRC reconfiguration).

### Configuration Related to Small Data Transmission

The configuration may be (or include) any of: SDT-Config, SDT-MAC-PHY-CG-Config, SDT-ConfigCommonSIB, MT-SDT-ConfigCommonSIB, CG-SDT-Configuration, and/or a Small Data Transmission (SDT) configuration.

The UE (e.g., ambient IoT UE/device, the first UE, the same below) may be configured with at least a configuration related to small data transmission. The UE may be pre-configured with at least the configuration. The UE may use (or apply) a pre-configured (or fixed) value for the configuration. The UE may not require the configuration. The UE may not require the network to provide the configuration.

For another type of UE (e.g., non-ambient IoT UE, the second UE, the same below), the UE may receive the configuration by system information and/or a dedicated RRC signaling (e.g., RRC reconfiguration).

### Miscellaneous

The configuration may be (or include) any of: configuration related to uplink control information, PUCCH-ConfigCommon, a scheduling request configuration, a Sounding Reference Signal (SRS) configuration, a Packet Data Convergence Protocol (PDCP) configuration, a Radio Link Control (RLC) configuration, an RLC channel configuration, a logical channel configuration, a radio bearer configuration, a Buffer Status Report (BSR) configuration, a Power Headroom Report (PHR) configuration, a Discontinuous Reception (DRX) configuration, MAC-CellGroupConfig, a timing advance configuration, a Timing Advance (TA) timer configuration, a TA report configuration, a radio link monitoring configuration, a measurement configuration, a measurement gap configuration, a measurement object configuration, and/or a measurement report configuration.

The UE (e.g., ambient IoT UE/device, the first UE, the same below) may be configured with at least the configuration. The UE may be pre-configured with at least the configuration. The UE may use (or apply) a pre-configured (or fixed) value for the configuration. The UE may not require the configuration. The UE may not require the network to provide the configuration.

For another type of UE (e.g., non-ambient IoT UE, the second UE, the same below), the UE may receive the configuration by system information and/or a dedicated RRC signaling (e.g., RRC reconfiguration).

The first UE may be an ambient IoT UE/device. The first UE may not be a normal (or legacy) UE. The first UE may be a first type of UE. The first UE may be a first type of ambient IoT UE.

The second UE may not be an ambient IoT UE/device. The second UE may be a normal (or legacy) UE. The second UE may be a second type of UE. The second UE may be a second type of ambient IoT UE.

The first UE and the second UE may be different. The first UE and the second UE may be of different UE types. The first UE (or UE type) and the second UE (or UE type) may be differentiated based on at least a first factor. The first factor may be one or more of the following.

### UE Type

There may be two or more types of UEs. The UE types may be differentiated by at least energy storage, method to perform UL transmission, power level, and/or device size. Preferably in certain embodiments, the method to perform UL transmission may be generated internally by the device/UE or be backscattered on the carrier wave (signal) provided externally. The UE types may comprise device A, device B, and/or device C.

For example, a first type UE may be a device A or device B, e.g., as considered in [2] 3GPP TR 38.848 V18.0.0. The first type UE may have (or be equipped with) battery or energy storage. The first type UE may not have (or be equipped with) battery or energy storage. The first type UE may not have (or be equipped with) DL/UL amplification. The first type UE may be a passive or semi-passive device. The first type UE may generate UL transmission by backscattering. The first type UE may perform backscattering transmission. The first type UE may not be able to generate UL transmission (internally) by itself. The first type UE may not have the capability to generate a signal without backscattering.

For example, a second type UE may be a device C, e.g., as considered in [2] 3GPP TR 38.848 V18.0.0. The second type UE may have (or be equipped with) battery or energy storage. The second type UE may have (or be equipped with) DL/UL amplification. The second type UE may be an active device. The second type UE may generate UL transmission by backscattering. The second type UE may perform backscattering transmission. The second type UE may be able to generate UL transmission (internally) by itself. The second type UE may have the capability to generate a signal without backscattering.

### Power Level

The power level may comprise any one or more of the following embodiments. The UE may utilize the same or different power level embodiment(s) for different RA resources selection (step(s)), e.g., determination of BWP, determination of RA resources/configuration group, determination of RA type, determination of RA preamble, determination of Random Access Channel (RACH) occasion(s), determination of Physical Uplink Shared Channel (PUSCH) occasion(s) and/or determination of PDRCH occasion(s). There may be one or more thresholds for power level. The power level may be determined by the threshold(s). The threshold(s) for power level may be configured by the network or be derived by the UE. The threshold(s) for power level may be determined based on the following embodiments and/or a (selected) RA resources/configuration.

In one embodiment, the power level may be a received power of a signal/channel transmitted from the network. The power level may be a received power of a carrier-wave (signal) transmitted from the network.

In one embodiment, the power level may be a (downlink) pathloss derived/determined based on at least the received power of the signal/channel transmitted from the network. The power level may be a (downlink) pathloss derived/determined based on at least the received power of the carrier-wave (signal) transmitted from the network.

In one embodiment, the power level may be an expected/derived/determined UE transmit power for backscattering transmission (e.g., the first transmission and/or the third transmission).

In one embodiment, the power level may be an expected/derived/determined UE transmit power for UL transmission generated internally by the UE (e.g., the first transmission and/or the third transmission).

In one embodiment, the power level may be a maximum UE transmit power (e.g., for the first transmission and/or the third transmission).

In one embodiment, the power level may be an amount of the UE's battery power/stored power/available power. The UE may estimate/determine/derive how much the battery power/stored power/available power is utilizable/available for performing (corresponding) an RA procedure.

In one embodiment, the power level may be a predefine/(pre-) configured/indicated power. The indicated power can be indicated by the network or by the higher layer of the UE. Preferably in certain embodiments, the predefine/(pre-) configured/indicated power can be a guaranteed or required power (amount or capacity) for enabling/activating/starting (corresponding) the RA procedure. Preferably in certain embodiments, the predefine/(pre-) configured/indicated power can be an expected/estimated power consumption (amount) for completing the (corresponding) RA procedure.

In one embodiment, the power level may be a power difference between the (downlink) pathloss and the expected/derived/determined/maximum UE transmit power. The (downlink) pathloss may be derived/determined based on at least received power of the signal/channel, e.g., a carrier wave (signal), from the network. The expected/derived/determined UE transmit power may be for backscattering transmission or for UL transmission generated internally by the UE.

In one embodiment, the power level may be a power difference between the battery power/stored power/available power and the expected/derived/determined/maximum UE transmit power. The expected/derived/determined UE transmit power may be for backscattering transmission or for UL transmission generated internally by the UE. The UE may estimate/determine/derive how much the battery power/stored power/available power is utilizable for performing the (corresponding) RA procedure.

In one embodiment, the power level may be a power difference between a predefine/(pre-) configured/indicated power and the expected/derived/determined/maximum UE transmit power. The indicated power can be indicated by the network or by the higher layer of the UE. Preferably in certain embodiments, the predefine/(pre-) configured/indicated power can be a guaranteed or required power (amount or capacity) for enabling/activating/starting the (corresponding) RA procedure. Preferably in certain embodiments, the predefine/(pre-) configured/indicated power can be an expected/estimated power consumption (amount) for completing the (corresponding) RA procedure. The expected/derived/determined UE transmit power may be for backscattering transmission or for UL transmission generated internally by the UE.

### UL Data Type

The UL data types may be differentiated by at least use case, traffic scenario, service type, Quality of Service (QOS), logical channel (group), and/or topology. The UL data type may be indicated by the network or indicated by the higher layer of the UE. The UE may initiate or trigger the RA procedure for transmitting the UL data.

### UL Data Size

The UL data size may be calculated/derived/determined by the UE. The UL data size may be corresponding to the UL data type. The UL data size may be (potential) Transport Block Size (TBS) of a Message A (MSGA) payload and/or a Msg3. The UL data size may be (potential) TBS of the first transmission in the RA procedure. The UL data size may be TBS of ambient IoT information (or data). The UE may initiate or trigger the RA procedure for transmitting the UL data.

### UE ID

A UE may be assigned a UE ID. The UE may be predefined or (pre-) configured (e.g., by the UE) the UE ID. The UE may be configured or indicated (e.g., by the NW) the UE ID. The UE may calculate, select, derive, or determine the UE ID by itself. An identity of the UE and/or a UE ID may be or comprise a random number, a temporary number, a preamble number, and/or an ID selected/generated/determined by the UE. An identity of the UE and/or a UE ID may be or comprise a device ID, a UE ID, a group ID, an Application Server (AS) ID and/or a Radio Network Temporary Identifier (RNTI) of the UE.

### UE Group

There may be multiple UE groups. A UE may be assigned or associated with a UE group. The UE may be predefined or (pre-) configured (e.g., by the UE) with the UE group. The UE may be configured or indicated (e.g., by the NW) with the UE group. The UE may receive a group ID and/or a value to derive/determine the group ID via paging, System Information Block (SIB), and/or PDCCH.

The multiple UEs may be assigned to different UE groups based on the UE types. The UEs with the same UE type may be in a same UE group. The UEs with the same UE type may be in different UE groups. A UE group may comprise UEs with the same or different UE type.

The multiple UEs may be assigned to or associated with different UE groups based on the UE ID. For example, a UE may be assigned to or associated with a UE group, wherein the UE group ID of the UE group may be decided/derived/determined based on at least the UE ID of the UE and a value. Preferably in certain embodiments, the UE group ID of the UE may be decided/derived/determined by the UE ID mod the value. The value may be the number of UE groups. The value may be provided by the NW or be pre-defined or be (pre-) configured. The UE group ID of the UE may be decided by a formula using the UE ID.

The multiple UEs may be assigned to different UE groups based on location. Preferably in certain embodiments, the UEs in a same location and/or a same position range may be distributed to the same UE groups. A UE may determine/derive its location or range based on a received carrier wave (signal), R2D signal/channel, and/or PRDCH. More specifically, the UE may determine/derive its location or range from a network/intermediate node based on a received power of a carrier wave (signal), R2D signal/channel, and/or PRDCH transmitted from the network/intermediate node. The UEs in the same location and/or the same range may mean the UEs with the same received power range of the carrier wave (signal), R2D signal/channel, and/or PRDCH. Preferably and/or alternatively in certain embodiments, the UEs in a same location and/or same position range may be distributed to different UE groups. The UEs among the range which could receive the same power source, carrier wave, R2D signal/channel, and/or PRDCH, and/or NW signaling may be (randomly) distributed to different UE groups.

Threshold(s) for the first factor may be indicated or configured by the NW. Alternatively, the threshold(s) may be determined by the UE. Alternatively, the threshold(s) may be fixed.

The UE may receive configurations related to ambient IoT. The UE may receive configurations and/or resources for (random) access (procedure). The resource(s)/configuration(s) may comprise a BWP, an access resources/configuration group, an access preamble (group), a RACH occasion(s), a PUSCH occasion(s), a PDRCH occasion(s), a frequency and/or band, e.g., for D2R transmission. The resource(s) and/or configuration(s) for the access procedure may comprise a parameter, a random number, a group number, and/or an assistance information, e.g., for D2R transmission. Throughout the present disclosure, the following may be interchangeable: RACH occasion(s), PRACH occasion(s), and/or PDRCH occasion(s). The PDRCH occasion(s) may be a time and/or frequency resource for a PDRCH transmission or a D2R transmission.

The power level may be (represented) a power status of the UE.

Throughout the present disclosure, the “RA procedure” may be replaced by “(initial) access procedure”, and/or access procedure performed by the (ambient IoT) UE/device. The (initial) access procedure may be contention-based or contention-free.

Throughout the present disclosure, the “RA procedure” may be changed/represented/replaced as a UE (or ambient IoT) (data) transmitting procedure, a UE (or ambient IoT) response procedure, or a UE (or ambient IoT) reporting procedure.

Throughout the present disclosure, the “RA” may be replaced by “access”.

Throughout the present disclosure, the “MSGA” or “MSGA payload” may be replaced by “(uplink/D2R) data and/or signaling”.

Throughout the present disclosure, the “PRACH” may be replaced by “channel for random access”, “PRACH for ambient IoT”, or “PDRCH”.

Throughout the present disclosure, the “PUSCH” may be replaced by “uplink shared channel”,

“PUSCH for ambient IoT”, or “PDRCH”.

Throughout the present disclosure, the “PDCCH” may be replaced by “downlink control channel”, “downlink control information”, “PDCCH for ambient IoT”, or “PRDCH”.

Throughout the present disclosure, the “PDSCH” may be replaced by “downlink shared channel”, “PDSCH for ambient IoT”, or “PRDCH”.

Throughout the present disclosure, the “RACH” may be replaced by “access channel”, “RACH for ambient IoT”, or “PDRCH”.

Throughout the present disclosure, the “cell” may be replaced by “intermediate node”.

Throughout the present disclosure, the network (node) may be changed/represented/replaced as intermediate node and/or reader.

Throughout the present disclosure, the (data and/or signaling) transmission from reader to device/UE may be via PRDCH. The (data and/or signaling) transmission from device/UE to reader may be via PDRCH.

Throughout the present disclosure, the “downlink control information” may be replaced by R2D control information.

Throughout the present disclosure, the “uplink control information” may be replaced by D2R control information.

Throughout the present disclosure, the “DL” may be replaced by “Reader to Device (R2D).” A DL transmission may be, be referred to, and/or be supplementary by a transmission from a reader to a device and/or an R2D transmission. A DL data may be, be referred to, and/or be supplementary by a data available on a reader side, a data to be transmitted from a reader to a device, and/or a R2D data. A DL transmission and/or DL data may comprise an indication, configuration, signal/signaling/signaling and/or message from a reader.

Throughout the present disclosure, the “UL” may be replaced by “Device to Reader (D2R).” A UL transmission may be, be referred to, and/or be supplementary by a transmission from a device to a reader and/or a D2R transmission. A UL data may be, be referred to, and/or be supplementary by a data available on a device side, a data to be transmitted from a device to a reader, and/or a D2R data. A UL transmission and/or UL data may comprise an indication, signal/signaling, and/or message from a device. A UL grant may be one or more resources provided from the reader/NW/intermediate node, used by the device/UE, and/or used to transmit/perform D2R transmission.

The UE may be referred to the UE, an RRC layer of the UE, a MAC entity of the UE, a physical layer of the UE, an AS layer of the UE, or an Ambient IoT (A-IoT) layer of the UE.

Throughout the present disclosure, the UE may be an ambient IoT device/UE. The UE may be a device used for ambient IoT. The UE may be a device capable of ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: (ambient IoT) UE, (ambient IoT) device.

The legacy UE may be a non-ambient IoT device. The legacy UE may perform different procedures from the ambient IoT UE. The UE may be a legacy UE with capability to perform ambient IoT procedure. Throughout the present disclosure, the following may be interchangeable: normal UE, legacy UE.

The ambient IoT UE may have capability of ambient IoT. The legacy UE may or may not have capability of ambient IoT procedure.

The network may be a network node. The network (node) may be a base station. The network (node) may be an access point. The network (node) may be an Evolved Node B (eNB). The network (node) may be a Next Generation Node B (gNB). The network (node) may be a gateway. The network may be or comprise a reader.

Various examples and embodiments of the present invention are described below.

Referring to FIG. 9, with this and other concepts, systems, and methods of the present invention, a method 1000 for a first UE in a wireless communication system comprises determining or deriving (at least) a first configuration by a first method, wherein the first configuration is determined or derived by a second UE by a second method (step 1002).

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) determine or derive (at least) a first configuration by a first method, wherein the first configuration is determined or derived by a second UE by a second method. Moreover, the CPU 308 can execute the program code 312 to perform all of the described actions, steps, and methods described above, below, or otherwise herein.

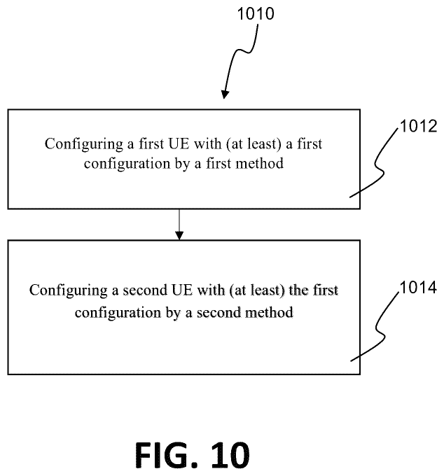

Referring to FIG. 10, with this and other concepts, systems, and methods of the present invention, a method 1010 for a network node in a wireless communication system comprises configuring a first UE with (at least) a first configuration by a first method (step 1012), and configuring a second UE with (at least) the first configuration by a second method (step 1014).

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) configure a first UE with (at least) a first configuration by a first method; and (ii) configure a second UE with (at least) the first configuration by a second method. Moreover, the CPU 308 can execute the program code 312 to perform all of the described actions, steps, and methods described above, below, or otherwise herein.

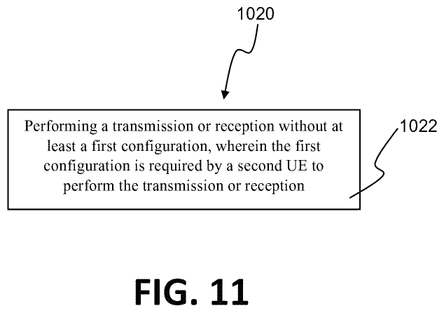

Referring to FIG. 11, with this and other concepts, systems, and methods of the present invention, a method 1020 for a first UE in a wireless communication system comprises performing a transmission or reception without at least a first configuration, wherein the first configuration is required by a second UE to perform the transmission or reception (step 1022).

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) perform a transmission or reception without at least a first configuration, wherein the first configuration is required by a second UE to perform the transmission or reception. Moreover, the CPU 308 can execute the program code 312 to perform all of the described actions, steps, and methods described above, below, or otherwise herein.

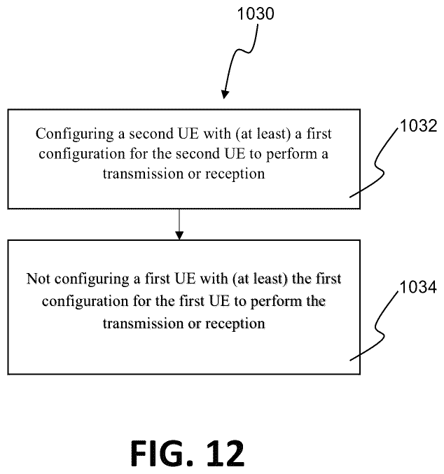

Referring to FIG. 12, with this and other concepts, systems, and methods of the present invention, a method 1030 for a network node in a wireless communication system comprises configuring a second UE with (at least) a first configuration for the second UE to perform a transmission or reception (step 1032), and not configuring a first UE with (at least) the first configuration for the first UE to perform the transmission or reception (step 1032).

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) configure a second UE with (at least) a first configuration for the second UE to perform a transmission or reception; and (ii) not configure a first UE with (at least) the first configuration for the first UE to perform the transmission or reception. Moreover, the CPU 308 can execute the program code 312 to perform all of the described actions, steps, and methods described above, below, or otherwise herein.

In various embodiments, the first UE is an ambient IoT UE/device.

In various embodiments, the second UE is not an ambient IoT UE/device.

In various embodiments, the first UE determines or derives a first value for the first configuration.

In various embodiments, the second UE determines or derives a second value for the first configuration.

In various embodiments, the first method or the second method is to receive a common signaling from a network node.

In various embodiments, the first method or the second method is to receive a dedicated signaling from a network node.

In various embodiments, the first method or the second method is to pre-configure or pre-define the first configuration.

In various embodiments, the first method and the second method are different.

In various embodiments, the first configuration includes a configuration related to SSB or CSI-RS.

In various embodiments, the first configuration includes a configuration related to BWP.

In various embodiments, the first configuration includes a configuration related to a random access procedure.

In various embodiments, the first configuration includes a configuration related to downlink control signaling.

In various embodiments, the first configuration includes a configuration related to a paging or system information.

To enable data and/or signaling transmission, an (ambient IoT) UE would trigger an RA procedure and/or initial access to the network. For example, the (ambient IoT) UE would receive a (first) signaling from the NW. In response to receiving the (first) signaling, the (ambient IoT) UE would trigger an RA procedure.

The (first) signaling may be used to trigger (or indicate) an RA procedure (or initial access) of the UE, as described above. The (first) signaling may be used to trigger (or indicate) a transmission (or reception) of the UE. The transmission from the UE may be (or include) a backscattering transmission (or reception) or may be generated internally by the UE. The (first) signaling may be used to provide power source and/or energy to the UE. The (first) signaling may be (or include) any of RRC signaling (e.g., RRC configuration message), MAC signaling (e.g., MAC CE), or PHY signaling (e.g., PDCCH, DCI). The (first) signaling may be (or include) a carrier wave (signal) and/or an interrogation signal.

The (first) signaling may be a common signaling or a dedicated signaling, as described above. The common signaling may be (or include) a cell-specific configuration. The common signaling may be (or include) a configuration common for multiple UEs, a group of UEs, and/or a UE group. The common signaling may be (or include) a broadcast signaling, system information, and/or paging, e.g., for ambient IoT. The dedicated signaling may be (or include) a UE-specific configuration. The dedicated signaling may be (or include) a configuration dedicated for a (single) UE. The dedicated signaling may be (or include) RRC signaling (e.g., RRC configuration message). The dedicated signaling may be (or include) MAC signaling (e.g., MAC CE). The dedicated signaling may be (or include) PHY signaling (e.g., PDCCH, DCI).

Due to characteristics of ambient IoT such as ultra-low complexity and ultra-low power consumption, it would not always be suitable for an ambient IoT UE to initiate an RA procedure, e.g., in response to receiving the signaling. The ambient IoT UE should check its ability to initiate an RA procedure, e.g., in response to receiving the signaling. Moreover, to reduce power consumption, enhancements on RA should be pursued to avoid collision between multiple ambient IoT UEs.

The UE may determine whether or when to initiate (or trigger, perform) an RA procedure in response to or after receiving an NW signaling (e.g., the first signaling or paging (for Ambient IoT)). The NW signaling may be a (first) signaling described above. The UE may determine whether or when to initiate (or trigger, perform) an RA procedure based on a first condition(s).

The UE may check the first condition(s) in response to (or if, when, after) receiving the NW signaling. If (at least) the first condition(s) is fulfilled, the UE may initiate, trigger, perform, continue, and/or resume an RA procedure. If (at least) the first condition(s) is not fulfilled, the UE may not initiate, trigger, and/or continue an RA procedure. If (at least) the first condition(s) is not fulfilled, the UE may stop, cancel, and/or suspend an RA procedure.

The UE may initiate, trigger, perform, continue, and/or resume an RA procedure, if (at least) the first condition(s) is fulfilled, after or in response to receiving the signaling. The UE may not initiate, trigger, and/or continue an RA procedure, if (at least) the first condition(s) is not fulfilled, after or in response to receiving the signaling. The UE may not initiate, trigger, continue, and/or resume an RA procedure until the first condition(s) is fulfilled, after or in response to receiving the signaling. The UE may stop, cancel, and/or suspend an RA procedure, if (at least) the first condition(s) is not fulfilled, after or in response to receiving the signaling. After or when the UE receives the NW signaling, the UE may check whether the first condition(s) is fulfilled or not. The UE may initiate an RA procedure once or after (at least) the first condition(s) is fulfilled. In response to (or if, when, after) receiving the NW signaling, the UE may initiate, trigger, continue, and/or resume an RA procedure once (at least) the first condition(s) is fulfilled.

Alternatively and/or additionally, the UE may initiate, trigger, continue, and/or resume an RA procedure in response to (or if, when, after) receiving the NW signaling. The UE may determine whether or when to perform the (very first or first time of or first step of) RA resource selection procedure (or RA preamble transmission procedure or MSGA transmission procedure) of the RA procedure based on a first condition(s).

The UE may check the first condition(s) when an RA procedure is pending. The RA procedure is pending when, upon, or after the UE receives the NW signaling and/or the RA procedure is triggered (e.g., by upper layer). The RA procedure is pending when, upon, or after the RA procedure is suspended. If the first condition(s) is fulfilled, the UE may perform the (very first or first time of or first step of) RA resource selection procedure (or RA preamble transmission procedure or MSGA transmission procedure) of the RA procedure. If the first condition(s) is not fulfilled, the UE may not perform the (very first or first time of or first step of) RA resource selection procedure (or RA preamble transmission procedure or MSGA transmission procedure) of the RA procedure.

The UE may check the first condition(s) in response to initiating, triggering, continuing, and/or resuming the RA procedure. If the first condition(s) is fulfilled, the UE may perform the (very first or first time of or first step of) RA resource selection procedure (or RA preamble transmission procedure or MSGA transmission procedure) of the RA procedure. If the first condition(s) is not fulfilled, the UE may not perform the (very first or first time of or first step of) RA resource selection procedure (or RA preamble transmission procedure or MSGA transmission procedure) of the RA procedure. If the first condition(s) is not fulfilled, the UE may delay and/or suspend the RA procedure.

The UE may perform the (very first or first time of or first step of) RA resource selection procedure (or RA preamble transmission procedure or MSGA transmission procedure) of the RA procedure, if the first condition(s) is fulfilled upon or in response to initiating, triggering, continuing, and/or resuming the RA procedure. The UE may not perform the (very first or first time of or first step of) RA resource selection procedure (or RA preamble transmission procedure or MSGA transmission procedure) of the RA procedure, if the first condition(s) is not fulfilled upon or in response to initiating, triggering, continuing, and/or resuming the RA procedure. The UE may not perform the (very first or first time of or first step of) RA resource selection procedure (or RA preamble transmission procedure or MSGA transmission procedure) of the RA procedure until the first condition(s) is fulfilled, after, or in response to initiating, triggering, continuing, and/or resuming the RA procedure. The UE may delay and/or suspend the RA procedure, if the first condition(s) is not fulfilled upon or in response to initiating, triggering, continuing, and/or resuming the RA procedure. After or when the UE receives the NW signaling and initiates, triggers, continues, and/or resumes an RA procedure, the first condition(s) may not be fulfilled. The UE may perform the (very first or first time of or first step of) RA resource selection procedure (or RA preamble transmission procedure or MSGA transmission procedure) of the RA procedure once or after the first condition(s) is fulfilled. In response to (or if, when, after) initiating, triggering, continuing, and/or resuming the RA procedure, the UE may perform the (very first or first time of or first step of) RA resource selection procedure (or RA preamble transmission procedure or MSGA transmission procedure) of the RA procedure once the first condition(s) is fulfilled.

The first condition(s) used to determine whether or when to initiate (or trigger, perform) an RA procedure and the first condition(s) used to determine whether or when to perform the (very first or first time of or first step of) RA resource selection procedure (or RA preamble transmission procedure or MSGA transmission procedure) of the RA procedure may be the same. Alternatively, the first condition(s) used to determine whether or when to initiate (or trigger, perform) an RA procedure and the first condition(s) used to determine whether or when to perform the (very first or first time of or first step of) RA resource selection procedure (or RA preamble transmission procedure or MSGA transmission procedure) of the RA procedure may be (partially or completely) different.

One or more first condition(s) may be applied by a first UE and may not be applied by a second UE, e.g., based on the first factor, as described above. A first UE and a second UE may have different configurations and/or values for the (one or more of) first condition(s). The first UE and the second UE may be different UEs, e.g., differentiated by the first factor. The first UE and the second UE may be ambient IoT UEs. The UE may determine whether to use the (one or more of) first condition(s) based on the first factor. The UE may determine to use which value of the (one or more of) first condition(s) based on the first factor.

The first condition(s) may be one or a combination of the following.

### Power Level

The first condition(s) may include that the power level is fulfilled, e.g., a threshold of the power level is fulfilled. For example, the first condition is fulfilled if (at least) the condition of a power level is fulfilled. The power level may comprise any one or more of the following embodiments. There may be one or more thresholds for (determining whether) the power level (is fulfilled). The power level may be determined by a threshold(s). The threshold(s) for power level may be configured by the network or be derived by the UE. The threshold(s) for the power level may be determined based on the following embodiments and/or a (selected) RA resource/configuration. The threshold(s) for power level may be indicated or configured by the NW. Alternatively, the threshold(s) for the power level may be determined by the UE. Alternatively, the threshold(s) for the power level may be fixed.

The threshold(s) may be derived based on a peak Transmission (TX) power of the UE. Alternatively and/or additionally, the threshold(s) may be derived based on a repetition number of a transmission (e.g., Msg1, preamble, MSGA, Msg3, or a UL transmission of the RA procedure) to be transmitted by the UE. Alternatively and/or additionally, the threshold(s) may be derived based on the first factor.

In one or more embodiments or examples, the power level may be as what is described above (e.g., for the first factor specified above).

For an instance, the first condition may include the received power is equal to or larger than a threshold.

For an instance, the first condition may include the pathloss is equal to or smaller than a threshold.

For an instance, the first condition may include the expected/derived/determined UE transmit power is equal to or larger than a threshold.

For an instance, the first condition may include the expected/derived/determined UE transmit power is equal to or larger than a threshold.

For an instance, the first condition may include the maximum UE transmit power is equal to or larger than a threshold. Alternatively, the first condition may include the maximum UE transmit power is equal to or smaller than a threshold.

For an instance, the first condition may include the amount of the UE's battery power/stored power/available power is equal to or larger than a threshold.

For an instance, the first condition may include the UE transmit power is equal to or larger than the predefine/(pre-) configured/indicated power. For an instance, the first condition may include a value is equal to or larger than the predefine/(pre-) configured/indicated power. The value may be derived/determined based on the expected/derived/determined/maximum UE transmit power and the repetition number, e.g., a value of “the expected/derived/determined/maximum UE transmit power” times/multiplying “the repetition number”.

For an instance, the first condition may include the power difference is equal to or smaller than a threshold or a value. The value may be derived/determined based on the expected/derived/determined/maximum UE transmit power and the repetition number, e.g., a value of “the expected/derived/determined/maximum UE transmit power” times/multiplying “the repetition number”.

For an instance, the first condition may include the power difference is equal to or larger than a threshold or a value. The value may be derived/determined based on the expected/derived/determined/maximum UE transmit power and the repetition number, e.g., a value of “the expected/derived/determined/maximum UE transmit power” times/multiplying “the repetition number”.

For an instance, the first condition may include the power difference is equal to or smaller than a threshold or a value. The value may be derived/determined based on the expected/derived/determined/maximum UE transmit power and the repetition number, e.g., a value of “the expected/derived/determined/maximum UE transmit power” times/multiplying “the repetition number”.

### UE Group

The first condition(s) may include that an information related to the UE's UE group (ID) or the UE's ID is received or indicated in the NW signaling (as described above). The NW signaling may indicate and/or comprise the group ID of the UE and/or the ID of the UE. The information may be (a part of) the UE's UE group (ID) or the UE's ID. For example, the first condition is fulfilled (at least) if the UE's UE group (ID) is received or indicated in the NW signaling (as described above). The first condition is fulfilled (at least) if the

UE's UE group (ID) is fulfilled a formula. The formula is pre-defined or (pre-) configured by the NW or the UE. The UE may determine the UE's UE group (ID) based on the first factor.

There may be multiple UE groups for ambient IoT. A UE may be assigned or associated with a UE group. The UE may be predefined or (pre-) configured (e.g., by the UE) with the UE group. The UE may be configured or indicated (e.g., by the NW) with the UE group. The UE may receive a group ID and/or a value to derive/determine the group ID via paging, SIB and/or PDCCH.

The multiple UEs may be assigned to or associated with different UE groups based on the UE types, UE ID, and/or location. More details may be as what is described above (e.g., for the first factor specified above).

### Proper Configuration

The first condition(s) may include that the proper configuration is received, available, and/or valid. For example, the first condition is fulfilled (at least) if the proper configuration is received, available, and/or valid. The first condition is fulfilled (at least) if a corresponding configuration for a first factor is received, available, and/or valid. The first condition is fulfilled (at least) if the configuration related to the first factor is received, available, and/or valid. The first condition is fulfilled (at least) if the configuration specific to one of the first factor is selected. The configuration may be associated with a first factor. The configuration may be different based on the first factor. The UE may determine whether a configuration is proper based on the first factor. The configuration may comprise any one or more of the configurations described above.

### Time Offset/Delay

The first condition(s) may include that a first time duration is passed or a current timing (e.g., when the UE receives an NW signaling, determines to initiate an RA procedure, and/or checks the first condition, when an RA procedure is pending or suspended) is after a first time duration. For example, the first condition is fulfilled (at least) if a first time duration is passed or a current timing is after a first time duration. The first time duration may be a time offset and/or time delay. The first time duration may be represented or counted by a first timer. The first time duration may be a duration when the first timer is running. The first condition is fulfilled (at least) if the first timer expires. The ((maximum) value of) first time duration may be configured, pre-defined and/or provided by the NW, e.g., via the NW signaling (as described above). The (value of) first time duration may be (randomly) selected, derived, and/or calculated by the UE (e.g., between 0 and the maximum value). The UE may determine the first time duration based on the first factor.

The first time duration may be used to delay (initiating, triggering, continuing, and/or resuming) an RA procedure. Alternatively and/or additionally, the first time duration may be used to delay performing the (very first or first time of or first step of) RA resource selection procedure (or RA preamble transmission procedure or MSGA transmission procedure) of the RA procedure. The first time duration and/or the first timer may be started when the NW signaling is received, an RA procedure is triggered or pending, the (one or more) first condition is fulfilled, the UE determines to initiate an RA procedure, the UE initiates (or triggers or continues or resumes) an RA procedure, (one or more) RA resources selection (step) is performed, and/or a transmission (of MSGA/msg1/msg3) is performed.

### Prohibit Timer

The first condition(s) may include that a second time duration is passed or a current timing (e.g., when the UE receives an NW signaling, determines to initiate an RA procedure and/or checks the first condition, when an RA procedure is pending or suspended) is after a second time duration. The second time duration may be counted or represented by a second timer. For example, the first condition is fulfilled (at least) if a second timer is not running. The first condition is fulfilled (at least) if the second timer expires. The second timer may be a time window. The ((maximum) value of) second time duration may be configured, pre-defined, provided, and/or enabled by the NW, e.g., via the NW signaling (as described above). The (value of) second time duration may be (randomly) selected, derived, and/or calculated by the UE (e.g., between 0 and the maximum value). The UE may determine the second time duration based on the first factor.

The second time duration may be used to prohibit the UE from initiating and/or performing an RA procedure. The second time duration may be used to prohibit the UE from initiating and/or performing an RA procedure in a short time (or promptly) after completing another RA procedure or before the RA procedure. The second time duration may be started when or in response to an RA procedure is triggered, (one or more) first condition(s) is fulfilled, the UE determine to initiate an RA procedure, (one or more) RA resources selection (step) is performed, a data or signal transmission (of MSGA/msg3/msg5) is performed, the RA procedure is (considered as) (successfully) completed. The data or signal transmission may use a PUSCH resource of an MSGA and/or UL grant provided from the NW. The data or signal transmission may be performed during the RA procedure or after the RA procedure is completed.

Alternatively and/or additionally, the UE may set a time stamp. The first condition(s) may include that the time stamp is passed or a current timing (e.g., when the UE receives an NW signaling, determines to initiate an RA procedure and/or checks the first condition, when an RA procedure is pending or suspended) is after the time stamp. Alternatively, the first condition(s) may include that the time stamp plus the second time duration is passed or a current timing (e.g., when the UE receives an NW signaling, determines to initiate an RA procedure and/or checks the first condition, when an RA procedure is pending or suspended) is after the time stamp plus the second time duration. The first condition is fulfilled (at least) after the time stamp. The time stamp may be configured, pre-defined, provided, and/or enabled by the NW, e.g., via the NW signaling (as described above). The time stamp may be (randomly) selected, derived, and/or calculated by the UE. The time stamp may be set by the value of the second timer. The time stamp may be set by the remaining time of the second timer. The time stamp may be set by the time or date (e.g., epoch time) that an RA procedure is triggered, (one or more) first condition(s) is fulfilled, the UE determine to initiate an RA procedure, (one or more) RA resources selection (step) is performed, a data or signal transmission (of MSGA/msg3/msg5) is performed, the RA procedure is (considered as) (successfully) completed.

Alternatively and/or additionally, the UE may store the value (or remaining time) of the second time duration or the time stamp, e.g., based on the power level. The UE may not clear the value (or remaining time) of the second time duration or the time stamp when, if, or in response to power turning off, going to idle state, and/or resetting MAC. The UE may retrieve and/or restore the value (or remaining time) of the second time duration or the time stamp, e.g., based on the power level.

The RA resources selection (step) may be (or comprise) selection of one or more of the following:
(initial) (UL) BWP (for ambient IoT);
RA resources/configuration (group) (for ambient IoT);
RA type (for ambient IoT);
RA preamble (group and/or index) (for ambient IoT);
RACH occasion (for ambient IoT);
PUSCH occasion (for ambient IoT); and/or
PDRCH occasion (for ambient IoT).

The UE may perform a procedure of RA, (initial) access, (ambient IoT) response/report, and/or (R2D/D2R) transmission. The procedure may be a procedure described above. The UE may access the NW/intermediate node, receive signaling/message/configuration, and/or transmit (D2R) data via the procedure. The UE may receive a signaling from the NW/intermediate node (e.g., from a reader). The signaling may be a signaling described above. The signaling may be a query, paging, indication, and/or a R2D message.

In response to receiving the signaling, the UE may trigger/perform the procedure and/or following transmission. In the procedure, the UE may transmit a first transmission to the NW/intermediate node. The NW/intermediate node may transmit a second transmission to the UE in response to reception/detection of the first transmission. In response to or after transmitting the first transmission, the UE may receive a second transmission from the NW/intermediate node. In response to receiving the second transmission, the UE may transmit a third transmission to the NW/intermediate node. In response to receiving the second transmission, the UE may not transmit the third transmission to the NW/intermediate node. The NW/intermediate node may transmit a fourth transmission to the UE in response to reception of the third transmission. The NW/intermediate node may not transmit the fourth transmission to the UE in response to reception of the third transmission. In response to or after transmitting the third transmission, the UE may or may not receive a fourth transmission from the NW/intermediate node. In response to receiving the fourth transmission, the UE may transmit a fifth transmission to the NW/intermediate node.

The first transmission in the procedure may be/comprise information of a random number, information of a preamble number, and/or information of a (access) ID selected/generated/determined by the UE.

The second transmission in the procedure may be a response to the first transmission and/or an acknowledgement. The second transmission may indicate, identify, and/or correspond to the first transmission. The second transmission may provide resource(s) for the following D2R transmissions, e.g., the third transmission.

The third transmission in the procedure may be/comprise information of a device/UE ID, report, assistance information, D2R data, and/or information from the UE.

The fourth transmission in the procedure may be a response to the third transmission, an acknowledgement, DL/R2D command, R2D data, and/or a scheduling. The fourth transmission may indicate, identify and/or correspond to the third transmission. The fourth transmission may provide resource(s) for the following D2R transmissions. The fourth transmission may indicate, notify, and/or allow the fifth transmission.

The fifth transmission in the procedure may be/comprise a feedback (of the fourth transmission), report, assistance information, D2R data, and/or information from the UE.

The first transmission, third transmission and fifth transmission may be D2R transmissions, and/or PDRCH transmissions. The signaling, second transmission, and fourth transmission may be R2D transmissions and/or PRDCH transmissions. The signaling and second transmission may be broadcast, provided and/or transmitted to one or multiple UEs. The second transmission and fourth transmission may be provided and/or transmitted to a dedicated UE. The fourth transmission and/or the fifth transmission may be a subsequent transmission during or after the procedure.

Various examples and embodiments of the present invention are described below.

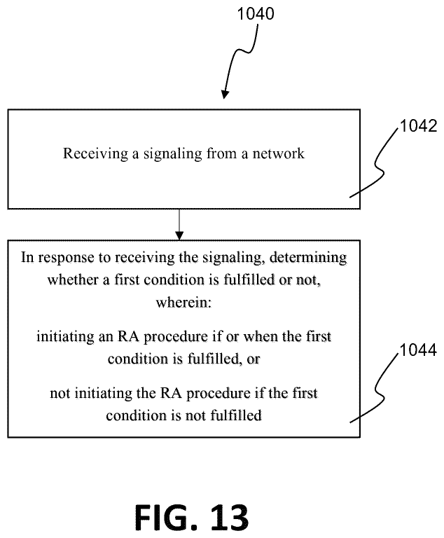

Referring to FIG. 13, with this and other concepts, systems, and methods of the present invention, a method 1040 for a UE in a wireless communication system comprises receiving a signaling from a network (step 1042), and in response to receiving the signaling, determining whether a first condition is fulfilled or not, wherein: initiating an RA procedure if or when the first condition is fulfilled, or not initiating the RA procedure if the first condition is not fulfilled (step 1044).

In various embodiments, the signaling indicates the UE to trigger the RA procedure and/or perform a UL transmission.

In various embodiments, the first condition is based on a power level of the UE.

In various embodiments, the first condition is based on an indication in the signaling and/or a UE group ID of the UE.

In various embodiments, the first condition is based on an RA configuration for the UE.

In various embodiments, the first condition is based on a time duration and/or a timer.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a signaling from network; and (ii) in response to receiving the signaling, determine whether a first condition is fulfilled or not, wherein: initiating an RA procedure if or when the first condition is fulfilled, or not initiating the RA procedure if the first condition is not fulfilled. Moreover, the CPU 308 can execute the program code 312 to perform all of the described actions, steps, and methods described above, below, or otherwise herein.

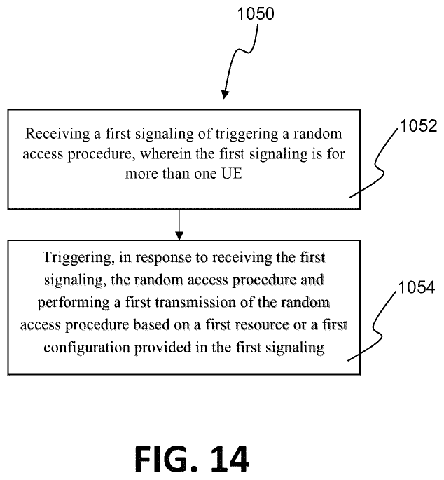

Referring to FIG. 14, with this and other concepts, systems, and methods of the present invention, a method 1050 for a UE in a wireless communication system comprises receiving a first signaling of triggering a random access procedure, wherein the first signaling is for more than one UE (step 1052), and triggering, in response to receiving the first signaling, the random access procedure and performing a first transmission of the random access procedure based on a first resource or a first configuration provided in the first signaling (step 1054).

In various embodiments, the first signaling is a paging for ambient IoT. In various embodiments, the first signaling is a paging message.

In various embodiments, the first signaling indicates a device ID of the UE, and/or the first signaling indicates a group ID of the UE.

In various embodiments, the first resource comprises at least a first frequency resource and/or a PDRCH occasion. In various embodiments, the first resource comprises at least the first frequency resource and/or an access occasion.

In various embodiments, the first resource is determined based on the first configuration and/or a pre-configuration.

In various embodiments, the first configuration is related to the random access procedure, and/or the first configuration is associated with the UE and/or a UE group of the UE.

In various embodiments, the first configuration provides any of a bandwidth part, one or more access resources, one or more access preambles, one or more PDRCH occasions, and/or one or more frequency resources for a D2R transmission (e.g., the first transmission).

In various embodiments, the first signaling is transmitted from a reader.

In various embodiments, the first transmission is transmitted to the reader during the random access procedure.

In various embodiments, the reader is any of a network node, an intermediate node or another UE. In various embodiments, the another UE is a non-ambient IoT UE. In various embodiments, the another UE is a legacy UE.

In various embodiments, the UE is an ambient IoT UE or an ambient IoT device.

In various embodiments, the more than one UE are ambient IoT UEs or ambient IoT devices.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of triggering a random access procedure, wherein the first signaling is for more than one UE; and (ii) trigger, in response to receiving the first signaling, the random access procedure and performing a first transmission of the random access procedure based on a first resource or a first configuration provided in the first signaling. Moreover, the CPU 308 can execute the program code 312 to perform all of the described actions, steps, and methods described above, below, or otherwise herein.

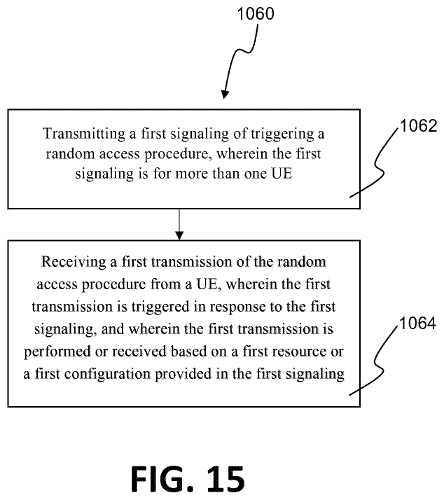

Referring to FIG. 15, with this and other concepts, systems, and methods of the present invention, a method 1060 for a reader in a wireless communication system comprises transmitting a first signaling of triggering a random access procedure, wherein the first signaling is for more than one UE (step 1062), and receiving a first transmission of the random access procedure from a UE, wherein the first transmission is triggered in response to the first signaling, and wherein the first transmission is performed or received based on a first resource or a first configuration provided in the first signaling (step 1064).

In various embodiments, the first signaling is a paging for ambient IoT. In various embodiments, the first signaling is a paging message.

In various embodiments, the first signaling indicates a device ID of the UE, and/or the first signaling indicates a group ID of the UE.

In various embodiments, the first resource comprises at least a first frequency resource and/or a PDRCH occasion. In various embodiments, the first resource comprises at least the first frequency resource and/or an access occasion.

In various embodiments, the first resource is determined based on the first configuration and/or a pre-configuration.

In various embodiments, the first configuration is related to the random access procedure, and/or the first configuration is associated with the UE and/or a UE group of the UE.

In various embodiments, the first configuration provides any of a bandwidth part, one or more access resources, one or more access preambles, one or more PDRCH occasions, and/or one or more frequency resources for a D2R transmission.

In various embodiments, the reader is any of a network node, an intermediate node or another UE. In various embodiments, the another UE is a non-ambient IoT UE.

In various embodiments, the UE is an ambient IoT UE or an ambient IoT device.

In various embodiments, the more than one UE are ambient IoT UEs or ambient IoT devices.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a first signaling of triggering a random access procedure, wherein the first signaling is for more than one UE; and (ii) receive a first transmission of the random access procedure from a UE, wherein the first transmission is triggered in response to the first signaling, and wherein the first transmission is performed or received based on a first resource or a first configuration provided in the first signaling. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first signaling of triggering a random access procedure, wherein the first signaling is for more than one UE; and
triggering, in response to receiving the first signaling, the random access procedure and performing a first transmission of the random access procedure based on a first resource or a first configuration provided in the first signaling.

2. The method of claim 1, wherein the first signaling is a paging for ambient Internet of Things (IoT), and/or the first signaling is a paging message.

3. The method of claim 1, wherein the first signaling indicates a device Identity (ID) of the UE, and/or the first signaling indicates a group ID of the UE.

4. The method of claim 1, wherein the first resource comprises at least a first frequency resource and/or a Physical Device-to-Reader Channel (PDRCH) occasion, or the first resource comprises at least the first frequency resource and/or an access occasion.

5. The method of claim 1, wherein the first resource is determined based on the first configuration and/or a pre-configuration.

6. The method of claim 1, wherein the first configuration is related to the random access procedure, and/or the first configuration is associated with the UE and/or a UE group of the UE.

7. The method of claim 1, wherein the first configuration provides any of a bandwidth part, one or more access resources, one or more access preambles, one or more PDRCH occasions, and/or one or more frequency resources for a Device-to-Reader (D2R) transmission.

8. The method of claim 1, wherein the first signaling is transmitted from a reader, and/or the first transmission is transmitted to the reader during the random access procedure.

9. The method of claim 8, wherein the reader is any of a network node, an intermediate node or another UE.

10. The method of claim 1, wherein the UE is an ambient IoT UE or an ambient IoT device.

11. A method of a reader, comprising:
transmitting a first signaling of triggering a random access procedure, wherein the first signaling is for more than one User Equipment (UE); and
receiving a first transmission of the random access procedure from a UE, wherein the first transmission is triggered in response to the first signaling, and wherein the first transmission is performed or received based on a first resource or a first configuration provided in the first signaling.

12. The method of claim 11, wherein the first signaling is a paging for ambient Internet of Things (IoT), and/or the first signaling is a paging message.

13. The method of claim 11, wherein the first signaling indicates a device Identity (ID) of the UE, and/or the first signaling indicates a group ID of the UE.

14. The method of claim 11, wherein the first resource comprises at least a first frequency resource and/or a Physical Device-to-Reader Channel (PDRCH) occasion, or the first resource comprises at least the first frequency resource and/or an access occasion.

15. The method of claim 11, wherein the first resource is determined based on the first configuration and/or a pre-configuration.

16. The method of claim 11, wherein the first configuration is related to the random access procedure, and/or the first configuration is associated with the UE and/or a UE group of the UE.

17. The method of claim 11, wherein the first configuration provides any of a bandwidth part, one or more access resources, one or more access preambles, one or more PDRCH occasions, and/or one or more frequency resources for a Device-to-Reader (D2R) transmission.

18. The method of claim 11, wherein the reader is any of a network node, an intermediate node or another UE.

19. The method of claim 11, wherein the UE is an ambient IoT UE or an ambient IoT device.

20. A User Equipment (UE), comprising:
a memory; and
a processor operatively connected with the memory, wherein the processor is configured to execute a program code to:
receive a first signaling of triggering a random access procedure, wherein the first signaling is for more than one UE; and
trigger, in response to receiving the first signaling, the random access procedure and performing a first transmission of the random access procedure based on a first resource or a first configuration provided in the first signaling.
